(19) United States
(12) Patent Application Publication
(10) Pub. No.: US 2017/0302613 A1
(43) Pub. Date: Oct. 19, 2017

(54) Environment for Processing and Responding to User Submitted Posts

(71) Applicant: Original Skateboards, LLC, Newton, NJ (US)

(72) Inventor: Timothy Scott Imbrie, Newton, NJ (US)

(73) Assignee: Original Skateboards, LLC, Newton, NJ (US)

(21) Appl. No.: 15/486,914

(22) Filed: Apr. 13, 2017

Related U.S. Application Data
(60) Provisional application No. 62/324,619, filed on Apr. 19, 2016.

(51) Int. Cl. H04L 12/58; G06F 3/0484

(52) U.S. Cl. CPC H04L 51/32; H04L 51/22; G06F 3/0484

(57) ABSTRACT

Exemplary embodiments of the present disclosure relate to an environment programmed and/or configured to extract and process user-submitted posts (e.g., questions, comments, etc.) submitted by users to one or more sources (e.g., posts to one or more web pages). The posts can be processed by exemplary embodiments to advantageously facilitate efficient, timely, and/or effective responses to the posts based on specified criteria.

### CROSS REFERENCE TO RELATED APPLICATIONS

This application claims the benefit of priority to U.S. Provisional Application No. 62/324,619 filed on Apr. 19, 2016, the content of which is hereby incorporated by reference in its entirety.

### BACKGROUND

Many social media sites, social networking sites, blogs, forums, and other web pages allow users to submit posts (e.g., comments or questions). For example, users can post comments and/or questions to a web page, which may be responsive to the content of the web page (including responsive to other users' posts) or may not be responsive to the content of the web page. In either case, these user-submitted posts can provide opportunities for the business entities associated with the web page, as well as for other business entities that may be interested in the user-submitted posts, to interact with the users posting the comments or questions.

The task of monitoring and responding to user-submitted posts on a single web page can be manageable when the quantity of posts submitted by users to the web page remains low. However, when the quantity of posts becomes large, it can be difficult to maintain a desired level of responsiveness. As a result, user-submitted posts may go unanswered and/or may responses may be so delayed that the user who posted the comment or question has lost interest in receiving a response. To complicate matters, if an entity wanted to monitor and respond to user-submitted posts across several web pages, the entity may quickly become overwhelmed as the quantity of user-submitted posts exceeds the entity's resources for responding to the user-submitted posts.

A failure to adequately respond to user-submitted posts by an entity can represent lost opportunities to interact with customers (or potential customers), which may yield a positive impression of the entity in the mind of the customer and/or may lead to lost sales opportunities. While it may not be necessary or desirable to respond to each and every user-submitted post, entities can realize a benefit to responding to a subset of the user-submitted posts that are deemed to be important to the entity. However, efficiently identifying and responding to this subset of posts can be challenging to entities with limited resource devoted to scouring the web pages and responding to the subset of user-submitted posts.

### SUMMARY

In accordance with embodiments of the present disclosure, a computer-implemented method of processing user-submitted posts from one or more sources is disclosed. The method includes receiving a user-submitted post from a source; executing code to programmatically assign a priority to the user-submitted post based on a priority criteria; displaying the user-submitted post in a graphical user interface (GUI) based on the priority; receiving a response to the user-submitted post via the graphical user interface; and transmitting a response to the user-submitted post to the source for display by the source.

In accordance with embodiments of the present disclosure, a non-transitory computer-readable storage device configured to store instructions executable by a processing device is disclosed. Execution of the instructions by the processing device causes the processing device to implement a method that includes reading instructions to receive a user-submitted post from a source; reading instructions to programmatically assign a priority to the user-submitted post based on a priority criteria; reading instructions to display the user-submitted post in a graphical user interface (GUI) based on the priority; and reading instructions to transmit a response to the user-submitted post to the source for display by the source.

In accordance with embodiments of the present disclosure a system for processing user-submitted posts from one or more sources is disclosed. The system includes a non-transitory computer-readable medium and a processing device. The non-transitory computer-readable medium stores executable code for processing user-submitted posts from one or more sources. The processing device is in communication with the non-transitory computer-readable medium and is programmed to execute the executable instructions to receive a user-submitted post from a source; assign a priority to the user-submitted post based on a priority criteria; display the user-submitted post in a graphical user interface (GUI) based on the priority; and transmit a response to the user-submitted post to the source for display by the source.

Any combination of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an exemplary embodiment of an environment for processing user-submitted posts in accordance with the present disclosure.

FIG. 2 is a block diagram of another exemplary embodiment of an environment for processing user-submitted posts in accordance with the present disclosure.

FIG. 3 is a block diagram of yet another exemplary embodiment of an environment for processing user-submitted posts in accordance with the present disclosure.

FIG. 4 is a flowchart of an exemplary process for processing user-submitted posts, which can be implemented by an exemplary embodiment of the environment in accordance with the present disclosure.

FIG. 5 is a flowchart showing an exemplary post filtering process that can be implemented in accordance with exemplary embodiments of the present disclosure.

FIG. 6 is a flowchart showing an exemplary post prioritization process that can be implemented in accordance with exemplary embodiments of the present disclosure.

FIG. 7 is a flowchart showing an exemplary post classification process that can be implemented in accordance with exemplary embodiments of the present disclosure.

FIG. 8 is a flowchart showing an exemplary post distribution process that can be implemented in accordance with exemplary embodiments of the present disclosure.

FIG. 9 is a flowchart showing an exemplary response posting process that can be implemented in accordance with exemplary embodiments of the present disclosure.

FIG. 10 is a block diagram of an exemplary computing device for implementing embodiments of the present disclosure.

FIG. 11 is a block diagram of an exemplary client-server environment for implementing embodiments of the environment in accordance with the present disclosure.

FIG. 12 is a block diagram of an exemplary client-server environment for implementing a distributed embodiment of the environment in accordance with the present disclosure.

### DESCRIPTION OF EXEMPLARY EMBODIMENTS

Exemplary embodiments of the present disclosure relate to an environment programmed and/or configured to extract and process user-submitted posts (e.g., questions, comments, etc.) submitted by users to one or more sources (e.g., posts to one or more web pages). The posts can be processed by exemplary embodiments to advantageously facilitate efficient, timely, and/or effective responses to the posts based on specified criteria.

As one example, exemplary embodiments of the present disclosure can be implemented by a business entity to monitor selected YouTube Channel pages and/or video pages for user-submitted posts. The YouTube pages can be monitored for the benefit of the business entity and/or for the benefit of third party business entities wishing to utilize exemplary embodiments of the environment to access and respond to user-submitted posts via the environment. The user-submitted posts on the monitored YouTube pages can be automatically extracted from the servers and/or databases storing the user-submitted posts for the monitored YouTube pages. For example, exemplary embodiments of the environment described herein can extract posts from the YouTube pages by interfacing with the YouTube application program interface (API) provided by Google. The extracted user-submitted posts can be filtered, prioritized, and classified by exemplary embodiments of the environment to ensure that responses to user-submitted posts with the highest priority are generated before responses to user-submitted posts with lower priorities are generated.

After the user-submitted posts have been prioritized and/or classified (e.g., have been assigned a priority score and/or a category), exemplary embodiments of the environment can distribute the user-submitted posts to responders that can generate response to the user-submitted posts based on the priority and/or classification of each of the user-submitted posts. The responders can be employees and/or contractors of the business entity or business entities utilizing exemplary embodiments of the environment and/or can be persons unaffiliated with the business entities that have been identified as “experts” with respect to generating responses to user-submitted posts to facilitate crowdsourcing of responses to the posts.

The environment can collect, receive, and/or maintain information about the users that submit posts to the monitored sources (e.g., web pages), as well as about the responders responding to the posts, to generate user ratings and responder ratings, respectively. The user ratings can be used to prioritize and/or classify user-submitted posts as can information about the posts themselves. The responder ratings can be used to determine which of the responders should be selected to respond to the user-submitted posts.

Once a response to a user-submitted post is generated, the response can be posted to the page from which the user's post was extracted so that the user that submitted the post and/or other users viewing the page can view the response. In exemplary embodiments, the responses can be posted to the page immediately or after one or more conditions have been met. With respect the latter, exemplary embodiments of the environment can determine when to post responses to aid in maintaining a continuous and consistent presence of responses on a monitored page and/or to increase the effectiveness of the responses. By assigning a priority score to user-submitted posts, a user rating to users submitting posts, and a responder rating to responders responding to the posts, exemplary embodiments can efficiently and effectively identify and respond to user-submitted posts that may be of interest to the entity utilizing the exemplary embodiments of the environment.

While one exemplary implementation of exemplary embodiments of the present disclosure provides for monitoring and responding to user-submitted posts on YouTube pages, exemplary embodiments can be implemented to monitor and respond to user-submitted posts from other sources. For example, exemplary embodiments can be implemented to monitor and respond to user-submitted posts on Facebook, LinkedIn, Twitter, Pinterest, Tumblr, Instagram, and/or any other source that allows users to submit posts as described herein.

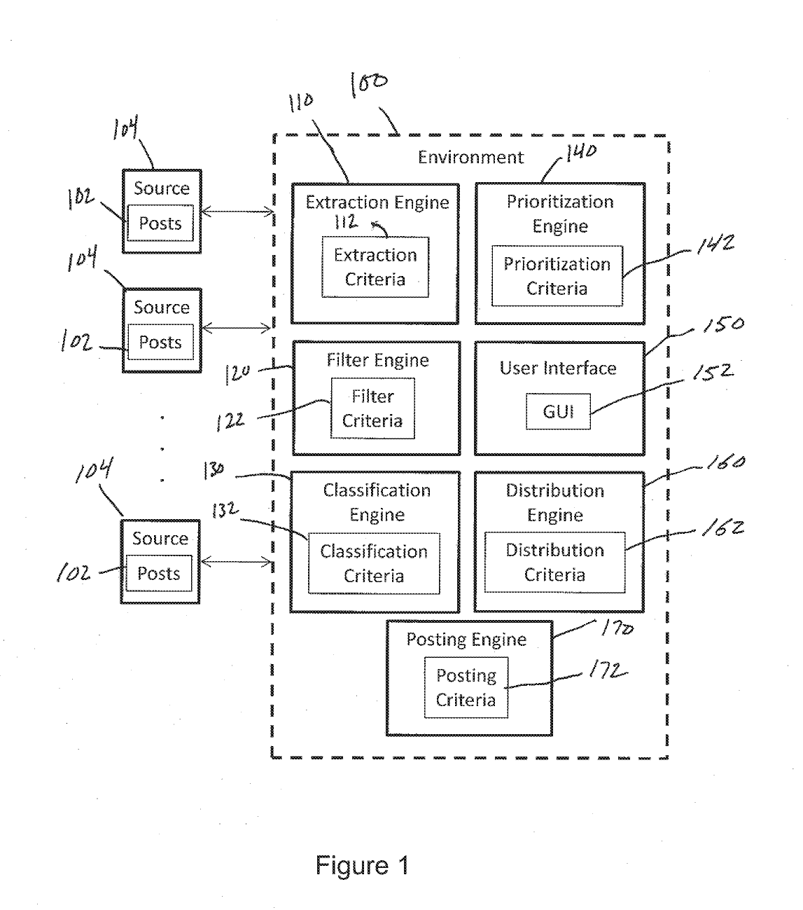

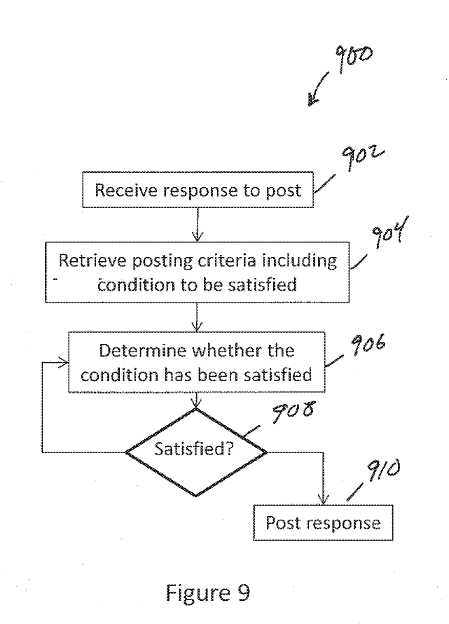

FIG. 1 is a block diagram of an exemplary environment 100 for processing user-submitted posts. Exemplary embodiments of the environment 100 can be implemented using hardware, software, and/or a combination thereof. For example, in one exemplary embodiment, one or more computing devices can be programmed and/or configured to implement exemplary embodiments of the environment 100. An exemplary embodiment of a computing device configured to implement embodiments of the environment 100, or portions thereof, is shown, for example, in FIG. 9. The environment 100 can include an extraction engine 110, a filter engine 120, a classification engine 130, a prioritization engine 140, a distribution engine 150, a user interface 160, and a posting engine 170. The environment 100 can be programmed and/or include executable code to implement one or more processes to facilitate processing and responding to user-submitted posts 102 (e.g., comments, questions, etc.) posted to one or more sources 104 including, but not limited to posts on social networking/media websites, such as YouTube, Facebook, LinkedIn, Twitter, Pinterest, Tumblr, Instagram, and the like, queries entered into search engines, and/or other suitable sources.

The extraction engine 110 can be programmed and/or configured to extract the user-submitted posts 102, and information associated therewith (e.g., metadata), from the sources 104. The extraction engine 110 can automatically extract user-submitted posts, can extract user submitted posts in response to operator interaction (e.g., the provider of the environment can instruct the engine 110 to extract posts 102), and/or can receive user-submitted posts automatically from a source. In exemplary embodiments, the extraction engine 110 can be programmed to extract/receive user-submitted posts from the sources 104 periodically and/or when a new post is submitted to the data sources. For example, user-submitted posts to one or more web pages can be stored in one or more databases and/or servers and the extraction engine 110 can be programmed and/or configured to access and retrieve the user-submitted posts from the databases and/or servers every minute, every five minutes, every hour, and so on, can be programmed and/or configured to access and retrieve the user-submitted posts in response to a notification from a source that a new user-submitted post has been received, and/or can be programmed and/or configured to automatically receive the user-submitted posts.

The extraction engine 110 can be programmed and/or configured to identify and retrieve user-submitted posts and related information (e.g., metadata) from the sources 104 by interfacing with an application program interface (API) or other software provided, for example, by or for the source. For example, the extraction engine 110 can programmatically create and transmit one or more queries to the API of a database and/or server to request the user-submitted posts associated with a specified web page, metadata associated with the user-submitted posts, and/or data metrics associated with the source that are stored by the database and/or server. Metadata associated with the user-submitted posts can include, for example, a user's identity, a time the post was submitted, a geographic location of the user submitting the post, and/or any other suitable user information. Metrics associated with the sources 104 can include, for example, a quantity of views of a web page, average viewing time of users visiting a web page, links selected by the user, a quantity of posts received within a specified time period, and/or any other suitable data metrics.

The extraction engine 110 can include extraction criteria 112 to: specify sources from which to retrieve/receive user-submitted posts, metadata, and metrics; specify which user-submitted posts, metadata, and metrics to retrieve/receive; and/or to specify a frequency with which the extraction engine 110 retrieves/receive user-submitted posts and metadata from sources.

The criteria 112 can include source identifiers, content identifiers, and/or a retrieval frequency. The source identifiers can include domain names, web pages, URLs, IP addresses, domain names, and/or any other suitable data source identifiers that can be used by the extraction engine 110 to identify data sources from which user-submitted posts can be retrieved/received (e.g., YouTube channels, social media hashtags, etc.). The content identifiers can include keywords/key terms and/or other parameters that can be used by the extraction engine 110 to programmatically search for and/or identify data sources from which to retrieve user-submitted posts. The retrieval/receipt frequency can include a time period (e.g., every 10 seconds, 1 minute, five minutes, hour, etc.) for retrieving/receiving posts. As another example, the extraction criteria 112 can include a parameter to specify whether to be notified of newly received user-submitted posts that satisfy the extraction criteria 112. As another example, the extraction criteria 112 can be include a parameter to specify whether to allow newly received posts satisfying the extraction criteria 112 to be sent to the environment 100 automatically when it is received by a source.

In exemplary embodiments, the sources from which user-submitted posts are retrieved/received can be specified manually and/or can by specified programmatically by the engine 110. For embodiments in which data source can be programmatically specified, the extraction engine 110 can automatically communicate with data sources (e.g., via API's provided by the data sources) to search for and/or identify sources from which user-submitted posts can be extracted based on the extraction criteria 112 to provide automated searching and extraction of user-submitted posts and/or to provide suggestions for new web pages to monitor for user-submitted posts to aid in identifying new opportunities that can be targeted by a business entity utilizing the environment 100.

The extraction engine 110 can be programmed and/or configured to extract metrics from the sources identified and suggested to the business entity by the extraction engine 110and/or identified by the business entity to provide the business entity with information about the source that may be useful to the business entity when deciding whether or not to monitor the source for user-submitted posts. For example, the extraction engine 110 can be programmed and/or configured to retrieve an average quantity of user-submitted posts posted over a specified time period (e.g., per hour, day, week, etc.), an average quantity of high priority user-submitted posts posted over a specified time period, an average quantity of low priority user-submitted posts posted by valuable users, and/or any other suitable metrics.

In some embodiments, during the source discovery and/or updating process implemented by the extraction engine 110, the extraction engine 110 can calculate a quantity of updates (e.g., a quantity of times to extract posts from a source within a time period) to facilitate cost effective updating of a database storing the extracted posts with new user submitted posts submitted to the source.

For example, the quantity of comments on a (You-Tube) video page (or other source location) per day, or per hour can be used to estimate how often the extraction engine 110 should query the video page (or the other source location). Source locations that receive very few user-submitted posts during a given hour of the day may not be queried often during that hour while videos or target locations that are known to be very active at a given hour are queried very frequently (possibly ever minute).

In some embodiments, the extraction engine 110 can programmatically rate and weight a source (e.g., a YouTube video page) on the likelihood that the next comment will be a valuable sales lead or other high value/high conversion type of post. In these instances a source location that has relatively low posts per day, or posts per hour, but a relatively high chance to produce a post of value may he queried more often than a source location which produces a large quantity of posts, but a relatively low chance to produce a post of value.

In some embodiments, the extraction engine 110 can allow an operator of the environment 100 (e.g., someone that uses the environment 100 to monitor and/or respond to user-submitted posts) to specify a frequency with which a source location is queried based on strategies that would range from very frequently (highest cost, fastest possible response) to very economically (most inexpensive but least frequent updates resulting in longer wait times for users asking questions).

In some embodiments, the extraction engine 110 can be configured to “listen” for updates utilizing a third party tool, such as, for example, Superfeedr, to notify or “push” information to the extraction engine 110. This allows the extraction engine 110 to receive information on an as needed basis, e.g., when there is a change or new post. The extraction engine 110 can receive either the updated information from the push service or simply receive notification that a given source location has a new user submitted post and the extraction engine 110 can query to the source location for the new user-submitted posts.

While some social media or other post location services send push notifications automatically, it is possible to enable this functionality even for those services that do not support this type of feed. Such push processes, such as Superfeedr and other subscription services, can be used to monitor these source locations (regardless of whether push notifications are supported).

Many sources (e.g., social media sites, blogs, etc.) that support user-submitted posts also support some form of promotion for user-submitted posts that are considered to be important or popular by the source or have received a positive indication from viewing users (e.g., a “like” or a “thumbs up”). Such user-submitted posts may he given preferential treatment by a source (e.g., based on the perceived importance, perceived popularity, or user response) such that these user-submitted posts have a higher likelihood of being viewed by other users because of their elevated, promoted, or featured status by the source. As one example, Facebook shows (by default) several of the most popular comments on an uploaded photograph, in combination with several of the most recent user submitted comment posts. These comments are the only user submitted posts that are visible when viewing the photograph in a data stream unless the viewing user takes further action and “expands” the full list of comments to view all comments, not just the few comments that Facebook views as important. Instagram uses functionality that is almost identical to the featured/promoted comment concept described at Facebook. As another example, similar to Facebook and Instagram, YouTube promotes several user submitted posts (based on positive voting from other users), but also creates several promoted locations (at the very top of all visible user submitted posts) reserved for comments that are posted to the video from the entity that uploaded the video).

All of these promoted comment locations serve to publicize popular user-submitted posts to encourage further interactions and to foster community building. These promoted post locations also offer companies using exemplary embodiments of the present disclosure an opportunity to gain exposure for responses to user-submitted posts. Since achieving, responding to, or maintaining a comment in a promoted location garners many more views, it can be valuable to understand if a response to a user-submitted post is being featured, and if not, which user-submitted post(s) are currently in the promoted location. This is because the content contained within the promoted user-submitted post(s) can have a greater impact and/or importance than user-submitted post(s) that have not been promoted by a source. Given the potential impact and/or importance of these promoted user-submitted posts (whether it is positive or negative), it can he important for an entity to monitor promoted user-submitted posts.

Exemplary embodiments of the extraction engine 110 can be programmed and/or configured to extract elevated, promoted, and/or featured user-submitted posts from sources being monitored by the system (e.g., source included in target pools) and these user-submitted posts can be displayed to an entity utilizing the system. For example, as described herein, many social media and/or slog services provide API(s) to facilitate extraction of user submitted posts that are currently being promoted by the social media and/or blog services in response to another user-submitted post (e.g., photograph, video, text post). When an API does not exist or allow for querying currently elevated, promoted, and/or feature user-submitted posts, the extraction engine can implement webscraping and push notifications (e.g., using Superfeedr or similar services) to update the systems database regarding which (if any) user submitted post(s) are being featured by a given source location for a given photo, video or text post at the source location.

The user 150 can be programmed and/or configured to render a graphical user interface that provides information regarding elevated, promoted, and/or featured posts on a per target pool basis or for all sources being monitored system. Since the extraction engine 110 can extract many source user-submitted posts (e.g., videos, photos, text posts, etc.), the system can provide for several different sorting processes to allow an administrator/operator to quickly analyze the most important elevated, promoted, and/or featured user-submitted posts.

In exemplary embodiments, user interface 150 can list of the user-submitted posts that have been elevated, promoted, and/or features and can provide a duration of time that the user-submitted posts were elevated, promoted, and/or featured as well as an estimate of how much exposure each elevated, promoted, and/or featured user-submitted post receives or received. By determining an exposure of a user-submitted post, exemplary embodiments of the system can estimate a value of the user-submitted post.

To determine an exposure of an elevated, promoted, and/or featured user-submitted post, the extraction engine 110 can query an API for a source location, scrape webpage of the source location, and/or interface with a push notification service (such as Superfeedr) to monitor the elevated, promoted, and/or featured status of a given post and to monitor a number of views received by the elevated, promoted, and/or featured user-submitted post from the first time the user-submitted post was featured, and the last time the user-submitted post was featured (when the comment is no longer featured). The extraction engine 110 can save these traffic statistics and can use this information to order and/or estimate an exposure of a given user-submitted post by dividing a total amount of time the user-submitted post was featured by a number of views that the user-submitted post received when it was featured.

For source locations that do not make the number of views publicly available, the system can be configured to use other data to estimate overall exposure. For instance, instagram does not support total view statistics, but it does support the number of “likes” a photo receives. In this instance, the extraction engine 110 can monitor a total number of “likes” received during the duration a given user-submitted post is featured by Instagram and can divide the total “likes” by the duration to generate a ratio that can used to order elevated, promoted, and/or featured user-submitted posts relative to one another with regards to overall exposure/visibility.

In some embodiments, when an entity (e.g., company) utilizing the environment 100 is looking/prospecting for additional sources of user-submitted or created posts to target for monitoring, the extraction engine 110 can be programmed and/or configured to analyze sources (e.g., web pages, YouTube channels, YouTube videos, etc.) to identify sentiments of the users submitting posts to the sources (e.g., the user base of the sources) based on, for example, whether users “like” (e.g., such as for FaceBook), “follow” (e.g., such as for Twitter, Instagram, etc.), “subscribe” (e.g., such as for YouTube or Blog sites), and/or provide any other suitable indication of interest. For example, exemplary embodiments of the extraction engine 110 can analyze the indications of interest, as well as, the user-submitted posts and user interests, which can be maintained by the sources for users who subscribe and/or post comments to the sources. User sentiment (as well as other metrics) can be used to determine which responder or group of responders (if any) will classify and/or answer user-submitted posts on the target sources and/or can also be used to add or exclude unknown or unproven sources from a given target group or pool of sources from which posts are extracted/recevied.

In exemplary embodiments, one or more target pools can be maintained as data structures or databases entries by the extraction engine 110 and can include information corresponding to source being monitored and from which user-submitted posts are being extract/received. The target pools can be can be generated based on one or more characteristics of the sources being monitored such that that can be several different target pools. In some embodiments, target pools can be nested such that a target pool can include a target sub-pool that includes a subset of source and/or user-submitted posts from the sources based on one or more criteria specified for the target pools.

Target pools can be formed using a criteria or rules (e.g., based on conditional statements) and target sources in a given target pool can change over time based on, for example, a performance of the target sources relative to the criteria or rules that have been created or specified to govern the target pool. For example, two target pools can be setup (e.g., a target pool A and a target pool B) to retrieve YouTube comment posts from channels/videos and the target pools can be utilized, e.g., by distribution engine 150, to distribute user-submitted posts from the sources included in the target pools to responders.

In the present example, the target pool A can be designated via the extraction engine 110 to contain all videos from Channel “X” that comply with several rules including, for example, a rule that adds all videos from Channel “X” to the target pool that contain a keyword “longboard” in the title or description; a rule that adds all videos from Channel “X” that contain the word “Skateboard” in the title, description or user generated tags; a rule that excludes all videos for which the word “Sector 9” is mentioned in the title, description or user created tags; and/or any other suitable rules for determining which user-submitted posts to include in a target pool.

In the present example, the target pool B can use conditional statements regarding the target pool A to create a performance based subset of sources contained within the target pool A. For example, the target pool B can include sources and/or user-submitted posts that consistently produce high quality sales leads as defined, for example, by the quantity of total comments from a source divided by the quantity of user-submitted posts from the source for which a response will be provided (e.g., which may be user-submitted posts that qualify as sales lead). In this example, the target pool B can include user-submitted posts to be answered by more advanced responders than the user-submitted posts in the target pool A.

One example of a conditional statement that can be utilized to create a rule for determining (e.g., by the extraction engine 110) which target pools contain which user-submitted posts can be a conditional statement that provides that target pool B should contain the top 10% of user-submitted posts from target pool A (as defined by sales lead generation). Using this approach can easily and/or efficiently allow effective and/or experienced responders to quickly respond to those user-submitted posts which may qualify as sales leads.

The remainder of user-submitted posts in target pool A can continue to be answered by the responders associated with the target pool A, while only the top 10% of target pool A can be moved to the target pool B. The sources that are represented in target pool B can remain members of target pool A or can be excluded from target pool A (e.g. depending on a preference or specification provided by the entity operating the environment 100). Since the exemplary conditional statement does not specifically refer to any singular source (e.g., YouTube video or YouTube Channel), the sources that make up the target pool B can change over time as different source become more or less effective, or more or less important to the entity's goals.

While an exemplary embodiment has been described with respect to a condition statement that specified a percentage chance that a user-submitted post (e.g. on a YouTube video) is relevant and valuable to the entity, those skilled in the art will recognize that other factors or criteria can be used. As one example, a target pool C can be created to target sources in target pool A for which at least 30% of the users who have written a comment post are also subscribers to a source managed and/or operated by the entity (e.g., a company's own YouTube channel) or are subscribers to some another source not that may not be managed or controlled by the entity. As other examples for determining a distribution of user-submitted posts into target pools can include a percentage chance for a user-submitted post to be a sales lead; a percentage of user-submitted post by known users; a percentage based on interactions by known user; a percentage of “hater” or negative user interaction, a first percentage of first or number of posts to find user subscriptions relative to channel(s); an analysis of total commenting users to find subscriptions relative to channel(s); an analysis of total commenting users to find subscriptions relative to channel(s) ; an analysis of a history of users submitting user-submitted posts to the sources to find interactions relative to one or more of the sources; an analysis of a history of users of a source regarding information, such as “likes”, “favorites”, “shares”, non-commenting interactions regarding or associated with a source; an analysis of participating users on a source based on a location of the users; and/or an analysis of participating users based on a known purchase history with a specified company.

In addition to the above, or alternatively, exposure, views, and/or source visibility can be variables or criteria that can be used to generate conditional statements that can be used by the extraction engine 110 to include and/or exclude sources and/or user-submitted posts from a given target pool. For example, a conditional statement that can be “include all video properties from channel(s) XX where views per day are greater than a threshold value, can be “include most viewed video properties (e.g., top 10%) from specified channels XX” and/or can be “include most commented on video properties (e.g., top 20%) from channel(s) XX”.

In some embodiments, the extraction engine 110 can be programmed and/or configured to sort user-submitted posts by the language in which the user-submitted posts are provided and/or can sort the user-submitted posts based on the geographic location of the users submitting the posts. For example, since a YouTube channel or other source may include user-submitted posts multiple languages and the popularity of a given video within a YouTube channel may change over time it can be helpful to establish the base language (e.g., most used language on a source) utilizing user-submitted posts to the source. This can be an accurate measure of a user population, since the creating owner may be of a different nationality/language persuasion than the users who end up interacting with the source.

Some variables or criteria that can be used to create language based mechanics can include, for example, a percentage of user created posts using a specified language, a percentage of user-submitted posts where users home geographic location is a specified country, a percentage of user-submitted posts where a user's selected language is maintained or identified, webpage titles in a specified language, webpage descriptions in a specified language, and/or any other suitable language based variables or criteria.

Continuing the above example using target pools, a target pool D can be created to hold all Spanish language content (for designation to bi-lingual or native Spanish speaking Responders). For example, a list of YouTube searches can be created to consolidate spanish “Video Reviews” of a given product, create conditional statements to pull Spanish user-submitted posts from target pools A, B, and/or C, and then to add monitoring of a Twitter search thread regarding “skates de long” or another Spanish keyword regarding the entity's product line. The user-submitted included in the target pool D can be matched to responders that can read and answer the user-submitted response in Spanish.

While some of the above non-limiting examples are described with respect to YouTube, those skilled in the art will recognize that exemplary embodiments can be utilized with respect to other websites or webpages (e.g., where views, likes, favorites, and/or other user interactions can be measured) can included in the target pools and can be subject to conditional statements that include or exclude the websites or webpages in one or more target pools. For example, a social media site, such as a Facebook page can include user-submitted posts and/or other interactions that can be used in conditional statements.

In exemplary embodiments, multiple conditional statements can be used by the extraction engine 110 to create a target pool that pulls user-submitted posts from several different target pools based upon variables or criteria that are included in the conditional statements. The conditional statements utilized to form a target pool can be inclusive or exclusive such that the conditional statements can be used to include certain sources or user-submitted posts and/or can be used to exclude certain source or user-submitted posts. As one example, sources and/or user-submitted posts can be removed that fit criteria of a condition exclusion statement, even though the sources and/or target pools may have been added from inclusion method (either conditional or otherwise). As another example, a conditional exclusion statement can be used by the extraction engine 110 to create a target pool that includes user-submitted posts that are suitable for less experienced responders (e.g., user-submitted posts that receive a lower level of overall exposure), while more experienced responders can be responsible for handling response to user-submitted posts that are viewed more frequently by other users and therefore may provide responses that are more influential.

In some embodiments conditional statements for target pool creation can be based on keywords in which the system can be configured to sort user-submitted posts from sources (e.g., YouTube video pages) into different target pools by keyword. As one example, a particular channel on YouTube can be identified based on a keyword that can correspond to content of the channel, such as videos related to products offered by different companies.

While user-submitted posts received for YouTube videos about a company's own products may be received positively (e.g. due to positive sentiment regarding the company), user-submitted posts and replies posted for YouTube videos about a competitors products may result in negative sentiment or feedback. For this reason, it may be important that responders to user-submitted posts for a company utilizing the environment 100 understand differences between targeting/responding to user-submitted posts associated with the company's products and targeting/responding to user submitted posts for videos corresponding to products of competitors to the company. In some embodiments, some responders can be granted access by the environment 100 to one type of user-submitted posts (e.g., posts for videos about the company's own products on a YouTube channel that is unaffiliated with the company), but may be denied access to other types of user submitted posts (e.g., posts for videos on the same YouTube channel that are related to competitor products. In these embodiments, the extraction engine 110 in conjunction with the distribution engine 150 can facilitate sorting of individual YouTube videos from a single YouTube channel (or sub-sites in a single site, or individual content pieces on single site, or individual user profiles on a given social media network) into separate target pools based on one or more keywords. An administrator selects the target location and then selects “sort by keyword” before entering a keyword or group of keywords. The administrator can then select to search/sort/classify videos either by keywords found in the title, found in the description, found in the tags, found in the text body of user comments found in the video/location itself or found using a formula that the administrator can create via the environment 100 to take all of those factors into account.

Multiple keywords or combination of keywords can be used to identify sources from which to extract user-submitted posts and the sources satisfying the keywords can be added to the selected target pool (for example the target pool might be “Original BoardShop Videos/Reviews”) by the extraction engine 110. In this manner, responders from the company “Original Skateboards” can be granted rights (e.g., by the distribution engine 150) to reply to comments from a video on YouTube channel of an unaffiliated company when the video title contains the word “Original” or “Original Skateboards” or “Original Longboards”.

Further rules can be specified regarding the channel of an unaffiliated company to target videos regarding other brands and/or any other keywords which may be used to identify user-submitted posts of interest. The videos returned in response to the keywords can be reviewed automatically and/or manually by the environment 100 to confirm whether user-submitted posts for the videos should be added to target pool.

When viewing a target pool (e.g., “Original BoardShop Videos/Reviews”), an administrator of the environment 100 can have access to and can view each source search query, with the corresponding returned YouTube videos in the list of individual targets (which can contain other types of content or locations other than YouTube content, such as, e.g., Twitter, Facebook, Instagram, etc.).

In some embodiments, an expected exposure for a user-submitted post (e.g. an expected number of views a specific user-submitted post receives) can be associated with the user-submitted post for automatic and/or manual designation of the user-submitted post or the source of the user-submitted post by the extraction engine 110 as a low exposure post/source or high exposure post/source, which can be utilized (e.g., by the distribution engine 110) for determining which responders or group of responders should receive the user-submitted post. The expected exposure can be utilized by the extraction engine 110 when forming target pools by including the expected exposure in a conditional statement/rule for determining which target pool should receive a user-submitted post. For example, user-submitted posts exceeding an expected exposure threshold can be directed by the extraction engine 110 to one target pool, while user-submitted posts with an expected exposure that is less than the expected exposure threshold can be directed by the extraction engine 110 to another target pool.

In some embodiments, the expected exposure can be determined by the extraction engine 110 by dividing a number of responses per day per hour by the number of users likely to see the post before the next response is posted. For example, the extraction engine 110 can be programmed and/or configured to track the number of views or likes a user-submitted post receives per minute, hour, day, week, etc, to facilitate these calculations.

In some embodiments, a source with few user-submitted posts can have many more views per response than sources with many user-submitted posts or user-submitted posts for which a response will/should be generated (e.g., if there is high volume of user-submitted posts fewer people may see a user submitted post). In these embodiments, an average number of responses to user-submitted posts for a given source can be determined by the extraction engine 110 to project a time period over which a response may be visible and/or relevant on the source.

In exemplary embodiments, the extraction engine 110 can be programmed and/or configured to add a given target source (e.g., universal resource locator (URL)) to a target pool for specified or dynamically determined time period and/or based on a performance of the source (e.g., whether relevant and/or valuable user-submitted posts are being extracted from the source) such that the source can be removed from the target pool upon expiration of the time period. By utilizing a time period for retaining the source in a target pool, the extraction engine 110 can be programmed and/or configured to limit a quantity of user-submitted posts being extracted and/or classified by the system when only a temporary duration of time is expected to generate valuable interactions between responders and users. When a time period for which a source will generate valuable interactions is not known, the extraction engine 110 can be programmed and/or configured to use rules to remove sources from target pools when it is determined that the sources do not perform to at least a given performance level.

When creating a target pool, a rule can be created for the target pools governing which source should be removed for unsatisfactory performance. For example, the rule can specify that a source must produce at least four valuable interactions (as classified “Need Response”) per month. Sources that do not produce the requisite number of valuable interactions can be removed from the target pool or queried less frequently (e.g., user-submitted posts can be extracted less frequently) by the extraction engine 110.

Since monitoring and/or extracting user-submitted posts from a source (e.g., querying a database associated with the source that stores the user-submitted posts) consumes bandwidth, system resources, and money, the rules allow the extraction engine 110 to be tuned for efficiency by dropping/discontinuing the monitoring of unpopular content with which users do not often interact. The extraction engine 110 can discontinue a source entirely, or simply be tuned to query the source less frequently in order to conserve system resources.

Another example where the rules can be used to control whether and when user-submitted posts are extracted from a source is when a YouTube video receives many user-submitted posts, but the user-submitted posts are generally not valuable or useful. Under these circumstances, if example the video receives three or more user-submitted posts per day, and at least one of the user-submitted posts are classified by the environment 100 as a post for which a response should be generated, the extraction engine 110 can retain the video in the target pool for a specified number of days after which the extraction engine 110 may automatically remove the video from the target pool or may again determine whether a user-submitted post for which a response should be generated has been posted for the source within a specified time period (e.g., a day). In some embodiments, a specified source in a given target pool as perpetual (meaning all rules applied to a given target pool are not applied to the specified source)

In this regard, a target pool being monitor can be groomed or controlled by the extraction engine 110 to include valuable and/or productive target sources based on preferences and/or criteria of the entity monitoring the target pool to improve the content of incoming user-submitted posts to be processed and/or to reduce an overall time that responders or the environment 100 spend to classify sources and/or user-submitted posts.

In some embodiments, social media sites/services (such as Facebook, Twitter, Instagram, Tumblr, etc.) allow searching for user-submitted posts to find recent user-submitted posts regarding a given topic (e.g., “Longboard”). To facilitate searching, a social media sites/service can provide an interface or application program interface (API) that is programmed to access to the user-submitted posts in response to search queries. In some embodiments, user-submitted posts that are returned to the extraction engine 110 in response to a search query for “longboard” on a social media site/service can be continually updated and the search results returned can contain user-submitted posts that may have been posted by any one of the collective group of users of the social media site/service so long as user-submitted posts contain the keyword “longboard” or the social media hash tag “#longboard”.

These keyword searches for use-submitted posts on a social media site/service can provide a valuable tool for finding users interested in a topic, product, event, etc., that may be important or of interest to a company monitoring and responding to user-submitted posts. The user may not be known or may not be interacting with any specific known content (either posted by the company or otherwise). For example, users can be interacting with themselves and/or possibly with their friends, followers, or contacts, but because user-submitted posts are publicly broadcast, many users may be looking for answers to their questions from, or to interact regarding the search subject (“longboard”) with, other users (which may be unknown to the user). For this reason, it can be valuable to interact with such users by responding to the user-submitted post because the interactions can result in additional “follows” or “Likes” to a company's Twitter, Facebook, or other social media site/service page and/or can result in sales of the company's products to the user.

To manage the ever changing, ever updating, lists of users and user-submitted posts related to a given search term, search origin pools can be created inside of a target pool. The target pools can contain one or more search origin pool entries which can include of a given site/service (e.g., Twitter) combined with a given search term or terms (e.g., “longboard”) and potentially a given programmatic rule regarding how to handle incoming user-submitted posts that are discovered through the searches.

Searching for user-submitted posts via an API, or other interface, associated with a social media site/service allows the extraction engine 110 to extract users and user-submitted posts for classification, action, and/or interaction by responders that may not have been extracted using a targeted source approach.

Since search origin pools can contain many individual search terms that may return identical user-submitted posts, the extraction engine 110 can compare a date and time associated with a user submitted post to other extracted user-submitted posts, and when multiple user-submitted posts have identical dates and times, the extraction engine 110 compares the content of the user-submitted post (e.g., text) to eliminate to prevent duplicate user-submitted posts from being processed by the extraction engine 110. This approach can be utilized prior to classification to expedite manual or programmatic classification of user-submitted posts by prevent redundant processing of by the environment 100. Since duplicate user-submitted posts can be removed, user-submitted posts can be efficiently classified and responded to. This can advantageously reduce an amount of resources and time that is devoted to classifying and responding to user-submitted posts.

In some embodiments, the extraction engine 110 can be programmed and/or configured to receive user-submitted posts (e.g., in the form of customer support comments/questions) directly through a website or application for a company utilizing the system. These incoming customer support questions/comments can be responded to by responders in a similar manner as user-submitted post extracted from other source locations. An administrator can specify that customer support questions/comments can be answered by company employees and/or third party responders that have some or no contractual affiliation with the company. For example, customer support questions/comments may be repetitive and/or easily answered by experienced responders who are not a direct part of the company but are third party responders authorized to respond to customer support questions/comments using the user interface 150 of the environment 100.

By extracting user-submitted posts from sources including social media, blogs, content posting services, as well as directly from the company's own website or application, the environment 100 advantageously can allow companies using the system to make use of their integrated responders to assist their customer support or sales staff. In some embodiments, forms, applications, and/or code that can communicate with the system can be implemented in a company's own website (or implemented anywhere else on the web) to allow user-submitted posts to be received directly by the extraction engine 110 from external users at designated source locations.

In some embodiments, an application program interface (API) can be implemented to allow other applications written by external developers to interface with the environment 100 and to facilitate receipt of user-submitted posts via applications utilizing the API. Once the extraction engine 110 has received a user-submitted post via the API, the user-submitted post can be handled in a similar manner as any other incoming user-submitted post processed by the environment 100. For example, similar to any content source location added to a target pool, incoming user-submitted posts received via a form and/or the API can be classified (manually or programmatically) and then made available for specified responder pool(s) to answer as responders become available. Many options can utilized to notify a user that submitted a user-submitted post via the form and/or API including, for example, push notifications to mobile phones or devices, notification by email, notifications by existing social media network services, and/or any other suitable notification mechanisms.

In exemplary embodiments, one or more responder pools can be maintained as data structures or databases entries by the distribution engine 160 and can include information corresponding to responders in the pools that can respond to user-submitted posts from monitored sources. The responder pools can be can be generated based on one or more characteristics of the responders such that there can be several different responder pools. In some embodiments, responder pools can be nested such that a responder pool can include a responder sub-pool that includes a subset of responders based on one or more parameters specified for the target pools.

In exemplary embodiments, the environment 100 can be programmed and/or configured to maintain a “Users of Interest” list and to generate a sub-list that associates the users with one or more classes of users. For example, user of interest can be divided into “haters” and “fans”. The extraction engine 110 can follow users included in the “Users of Interest” list to monitor user-submitted posts from the users for positive and/or negative sentiment towards the company utilizing the system and/or to identify valuable opportunities for interaction the users. In one non-limiting example, known “Haters” can be followed to allow company to refute (via responders) user-submitted posts, which are, for example, deemed to be negative towards the company or malicious. In another non-limiting example, known “Fans” can be followed by the system to prospect for new target sources or source locations to be targeted. In yet another non-limiting example, “Fans” can be followed in case they are debated by a “Hater”, in which case the administrator can target those user-submitted posts for refutation by responders.

In exemplary embodiments, the environment 100 can utilize browser extensions and/or iFrame based web layouts to facilitate functionality that allows an administrator to designate users to be included in the Users of Interest list within a web browser (such as firefox or Google Chrome). For example, using a browser that incorporates a browser extension, the administrator can to navigate through YouTube videos or other user generated content, while using the browser extension functionality to target individual users, or individual user generated posts for interaction by responders. By utilizing a browser extension and/or iFrame based web layout, exemplary embodiments of the environment 100 can expand the web based functionality of the system beyond the designation of Users of Interest to allow users, responders, and/or administrators to transmit valuable data to/for the company without changing navigation/viewing behaviors of the users, responders, and/or administrators while viewing content in a web browser.

The extraction engine 110 can generate a target score based on the metrics that can be used to compare the source with other sources. In some embodiments, the extraction engine 110 can generate a targeting accuracy metric for each source by factoring a quantity of responses posted to the source via the environment against a “response to response” scoring described below. A low targeting accuracy can be indicate that a business entity has been too aggressive in responding and targeting user-submitted posts from poorly selected sources (e.g., source with many external users who disagree with the companies expected position).

In one exemplary embodiment, at least one of the sources 104 can be a YouTube page. User-submitted comments (e.g., posts 102) to one or more YouTube channel pages or video pages can be stored in a database associated with the YouTube pages and can be accessible by the extraction engine 110 using the YouTube Data API provided by Google. The extraction engine 110 can use the YouTube Data API to programmatically interface with the database based on the extraction criteria 112 to retrieve the user-submitted comments for the one or more YouTube channel pages or video pages, metadata associated the user-submitted comments, and/or metrics for the one or more YouTube channel pages and/or video pages.

The filter engine 120 can be programmed and/or configured to filter the user-submitted posts retrieved by the extraction engine 110. The filter engine 110 can automatically filter user-submitted posts and/or can filter user submitted posts in response to operator interaction (e.g., the provider of the environment can instruct the engine 120 to filter posts 102),In exemplary embodiments, the filter engine 120 can apply filtering criteria 122 to the user-submitted posts 102 as they are retrieved from the sources 104. The user-submitted posts 102 that do not satisfy the filtering criteria 122 can be stored without further processing, stored and processed by the environment 100 without responding to the posts, deleted, and the like. The user-submitted posts 102 that satisfy the filtering criteria 122 can be stored and processed by the environment 100 to facilitate posting of one or more responses to the user-submitted posts 102.

The filtering criteria 122 can be specified to filter the user-submitted posts 102 based on, for example, relevance to the responding entity, interest to the responding entity, value to the responding entity, the user that submitted the post, and/or any other suitable basis for filtering the user-submitted posts 102. In exemplary embodiments, the user-submitted posts 102 can be filtered based on the content of the user-submitted posts 102 and/or the metadata associated with the user-submitted posts 102 (e.g., information about the user that submitted the post, a time at which the post was submitted). As one example, the filtering criteria 122 can include keywords/key terms that can be compared to the content of the user-submitted posts to determine whether the user-submitted posts are relevant, of interest, and/or of value to the responding entity. As another example, the filtering criteria 122 can include metadata restrictions that can be compared to the metadata associated with a user-submitted post. A metadata restriction can include, for example, a time restrictions such that user-submitted posts received by the one or more data sources after or within a specified time period (e.g., within the last day, week, month, year, etc.).

The classification engine 130 can be programmed and/or configured to classify the user-submitted posts 102 into one or more categories. The classification engine 130 can automatically classify user-submitted posts and/or more classify user submitted posts in response to operator interaction (e.g., the provider of the environment can instruct the engine 130 to classify posts 102),In some embodiments, the classification of the user-submitted posts 102 can be based on the contents and/or metadata of the user-submitted posts 102. For example, the classification engine 130 can classify the user-submitted posts 102 based on the subject matter or nature of the posts 102. Some examples of categories for the user-submitted posts 102 can include negative posts, positive posts, high priority posts, low priority posts, product inquiries, sales inquiries, technical questions, instructional requests, sales oriented comments, endorsements, complaints, and/or any other suitable categories.

In exemplary embodiments, the classification engine 130 can use classification criteria 312 to classify the user-submitted posts into the categories. The classification criteria 132 can include, for example, keywords/key terms (e.g., interrogatives—who, why, where, when, how; punctuation—question marks, exclamation marks) user identifiers, a time at which the user-submitted post 102 was received by the source, and/or any other suitable parameters. The classification criteria 132 can be specific to the categories such that the classification engine 130 can insert a user-submitted post into a category in response to satisfaction of the classification criteria 132 for that category. In some instances, a user-submitted post can satisfy the classification criteria 132 for more than one category. In some embodiments, when a user-submitted post satisfies the classification criteria 132 of more than one category, the classification engine 130 can be programmed and/or configured to insert the user-submitted post into two or more of the categories. In some embodiments, when a user-submitted post satisfies the classification criteria 132 of more than one category, the classification engine 130 can be programmed and/or configured to insert the user-submitted post into one of the categories based on, for example, a classification score that can be determined by the classification engine 130. A classification score for a user-submitted post can be determine, for example, by assigning values to classification criteria 132. As one example, a relevancy to a particular category can be determined based on a quantity of keywords/key terms that appear in a user submitted post, where each keyword/key term that appears in the user-submitted post can count as one point. The summation of points for a user-submitted post for each of the categories can be used to determine the category to which the user-submitted post is assigned.

The prioritization engine 140 can be programmed and/or configured to prioritize the filtered user-submitted posts. The prioritization engine 140 can automatically extract user-submitted posts and/or can prioritize user submitted posts in response to operator interaction (e.g., the provider of the environment can instruct the engine 110 to prioritize posts 102). The priority of the user-submitted posts can be based on a priority score that can be determined by the prioritization engine 140 using priority criteria 142. The priority criteria 142 can be used by the prioritization engine 140 to evaluate one or more priority factors associated with the content of the user-submitted posts, metadata associated with the user-submitted posts, and/or metrics associated with the sources from which the user-submitted posts are received. The one or more priority factors can influence the priority score of a user-submitted post. Some examples of priority factors that can be evaluated with the priority criteria 142 can include:
Relevance to an entity's products,
Relevance to an entity's industry
A time at which the comments were posted (e.g., where more recent posts receive a higher priority or less recent posts receive a higher priority)
The last time a response was posted to the web page in response to a user-submitted post
An identity of the user that posted the user-submitted post
A reputation of the user that posted the user-submitted post
A purchasing history of the user that posted the user-submitted post
Known interests of the user that posted the user-submitted post
A popularity (e.g., number of views) of the web page on which the user-submitted post is posted
A number of user-submitted posts posted on a web page per hour/day/week
Comparisons to activities on other web pages (e.g., when the last user-submitted post was posted on other web pages, when the last response was posted on other webpages, a popularity of the other web pages, a number of comments posted on other web pages per hour/day/week, etc.)
Likelihood that a response would lead to a sale of a product

User-submitted posts that receive a higher priority score relative to other user-submitted posts can have responses generated for them before responses are generated for user-submitted posts receiving low priority scores. In exemplary embodiments, the priority score of a user-submitted post can change dynamically with time. For example, in some embodiments, as a user-submitted post ages (e.g., as time elapses from submission of the user-submitted post), the priority score of the user-submitted post can decrease. In some embodiments, the user-submitted posts can be classified by classification engine 130 and subsequently prioritized for each category by the prioritization engine 140. In some embodiments, the user-submitted posts can be prioritized by the prioritization engine 140 and subsequently classified by classification engine 130. By prioritizing the user-submitted posts and then classifying them, exemplary embodiments of the present disclosure can advantageously identify high priority user-submitted posts early in the process to allow the high priority posts to be address quickly and efficiently.

In some embodiments, the user-submitted posts can be prioritized by the prioritization engine 140 using source information (e.g., metrics) retrieved from the one or more data sources. As one example, a user-submitted post can be a comment posted by a user on a video page (e.g., a web page) of YouTube. The comment can be prioritized by the prioritization engine 140 based on a comparison between a duration of time since a response was last posted to the video page and/or a duration of time since a response was posted on a competing video page on YouTube. For example, if a response was posted to a competing video page more recently than to the video page, the prioritization engine 140 can assign the user-submitted post a higher priority score than a user-submitted post from the competing video page being processed by the environment 100. This prioritization scheme can be facilitate prioritizing user-submitted posts from more than two video pages (e.g., web pages in which the videos are embedded) such that the video page having the greatest duration since a response was posted is assigned a higher priority score than the user-submitted posts from other video pages.

As another example, each filtered user-submitted post receives a priority score determined by the prioritization engine 140 based on the prioritization criteria 142, where the priority criteria is based on metrics from the source of the user-submitted posts (e.g., YouTube video web pages). For example, in some embodiments, the priority score can be determined by estimating a quantity of views of a web page in a specified time period (per hour, day, week, etc.) and calculating a quantity of impressions that are missed for each source of the user-submitted posts. More popular web pages can receive higher priority than less popular web pages. In some embodiments, a weighting can be applied to increase the priority score of user-submitted posts from a less popular web page, for example, to aid in evenly distributing the responses.

In some embodiments, the user-submitted posts can be prioritized by the prioritization engine 140 based on the content of the one or more user-submitted posts. For example, in some embodiments, the prioritization engine 140 can be programmed and/or configured to generate a prioritization score based on keywords/key terms identified in the user-submitted posts (e.g., interrogatives—who, why, where, when, how; product references; punctuation—question marks, exclamation marks; etc.) to estimate a relevance, interest, and/or value of the user-submitted posts to the responding entity. In some instances a higher prioritization score can be an indication of the likeliness to convert a sale if a response to the user-submitted post is provided.

In some embodiments, the user-submitted posts can be prioritized by the prioritization engine 140 based on user information associated with the one or more user-submitted posts. The user information can be maintained by the environment 100 in user pools and/or can be the metadata from the user-submitted posts. The prioritization engine 140 can be programmed and/or configured to generate a prioritization score based on information about each user including whether the user likes/follows the responding entity's brand (e.g., via Facebook or Twitter), whether the user likes/follows the other brands in the industry, a frequency with which the user posts to one or more of the data sources, account information (e.g., usernames), historic purchasing information about the user, user interests and activities (e.g., provided by the user and/or specified by the user on the user's Facebook or Twitter page), and/or any other suitable user information. The prioritization engine 140 can be programmed and/or configured to generate the prioritization score based on the user information to estimate a relevance, interest, and/or value of the user-submitted posts to the responding entity. In exemplary embodiments, the user information can be used to generate ratings for the users. The user ratings can be used instead of or in combination with the user information. In some instances a higher prioritization score can be an indication of the likeliness to convert a sale if a response to the user-submitted post is provided.

In exemplary embodiments, the user pools can be a maintained as data structures or databases entries by the environment and can include information corresponding to users associated with user-submitted posts that have been and/or are being extracted from the monitored sources. The user pools can be can be generated based on one or more characteristics of the users such that that can be several different user pools can be generated. In some embodiments, user pools can be nested such that a user pool can include a user sub-pool that includes a subset of users in a user pool based on one or more parameters specified for the user pools. By maintaining user pools including information about the users and using the user information to classify and/or prioritize user-submitted posts from users, exemplary embodiments of the environment 100 can amass a user knowledge base in which user values or scores can be assigned to the users in the user pools in groups and/or on a per-user basis (e.g., relative to keywords or topics) and then can wait for user-submitted posts from the users included in the user pools such that the user-submitted posts can be classified and/or prioritized based on the user scores as well as the content of the user-submitted posts. This can allow the environment 100 quickly and efficient process user-submitted posts associated with high priority users (e.g., users having an high score) and/or to quickly and efficiently process user-submitted posts associated with low priority users (e.g., users having a low score). For example, user-submitted posts associated with users having a high score can be classified and/or prioritized before user-submitted posts received around the same time that are associated with lower scoring users.

In some embodiments, the user-submitted posts can be prioritized by the prioritization engine 140 based on a combination of the source of the user-submitted posts, the content of the user-submitted posts, and/or the user information associated with the users that submitted the one or more user-submitted posts (e.g., including the user rating). In one exemplary embodiment, a source-rating based on the information about the sources, a content-based priority score based on the content of the user-submitted post, and a user rating based on the user information can each be generated and subsequently combined to form a composite priority score for a user-submitted post. The components of the composite priority score can be weighted to emphasize different information. For example, in one exemplary embodiment, the user-based priority score can be weighted more than the source-based and content-based priority scores.

In some embodiments, the prioritization engine 140 can be programmed and/or configured to perform a sequential multi-step prioritization process. For example, the prioritization engine 140 can generate a preliminary priority score based on the identity of the user that submitted the user-submitted post as a first step and then can refine or modify the priority score based on the content of the user-submitted post. To achieve this, exemplary embodiments of the prioritization engine 140 can assign and maintain user values for users that have submitted posts based on information collected for the users and/or prior posts submitted by the users. The user values can be used to assign a priority to a user submitted posts such that the identity of the user that submitted the post influences how quickly that a response is generated for the post. The user values can be created and retained by the prioritization engine 140 to allow the environment 100 to amass a list of users and their user values, which can be used when a post is received to determine an initial or preliminary priority score for the post. If the user value is high, the preliminary priority score can elevate the user-submitted post in the priority queue, which can then be modified based on the content of the user-submitted post. By generating a preliminary priority score based on the user's identity and subsequently modifying the priority score based on the content of the post, exemplary embodiments can be programmed and/or configured to advantageously prioritize posts based on a user's likelihood to buy products, submit important posts, solicit responses that provide a positive contribution to other users, and the like. This allows the environment 100 to identify and response to users with higher user values more quickly, rather than treating all users equally during the prioritization of user-submitted posts.

In exemplary embodiments, the classification engine 130 and/or the prioritization engine 140 can apply a “stickiness” rating to a thread of user-submitted posts, where “stickiness,” as used herein refers to a degree to which the environment 100 tracks, monitors, and/or values a thread to identify further opportunities for responding to user-submitted posts in the thread. Threads that have a higher stickiness rating than other threads provides may be more closely followed and/or monitored than other threads and may receive a higher priority for processing and/or responding to user-submitted posts in the thread. The stickiness rating can be applied manually or programmatically based on the perceived value of not only a response to a user-submitted post in the thread, but to the continuation of the thread after a response is posted. Increasing a stickiness of a user-submitted post or thread can raise the priority of any user-submitted posts posted to the current thread or any new user-submitted posts related to the user-submitted post to which a response was posted in the thread, even if the new user-submitted posts are not directly related to the thread, but which occur very close to the current thread activity and uses similar language to the user-submitted post based on factors determined by an administrator and/or the environment 100 within stickiness settings. For example, in some embodiments, the classification engine 130 and/or the prior can be programmed and/or configured to generate a stickiness rating, which can be retained or modified by an administrator. For embodiments in which classification is formed automatically and programmatically by the environment 100, the classification engine 130 and/or prioritization engine 140 can generate the stickiness ratings using algorithms and variables, which may be assigned by the administrator.

Some examples of variables that can be utilized when determining a stickiness rating can include, but are not limited to keywords, posts from specific user names that have already been involved in the thread, posts from users who have previously been involved in “sticky” threads, posts from users who frequently interact with a specific online property (a specific property or properties owned by a specific company YouTube channel, Facebook, Twitter or other social media location), posts that have a given number of likes or dislikes, and/or any other suitable variables that may indicate that a topic is either virally positive or virally negative in relationship to the brand or company utilizing the system.

In one non-limiting example, an administrator can designate an important user-submitted post by a user by requesting three third party responders to respond to the user-submitted post. In response to the designation, the environment 100 can find and match three third party responders who are well suited to answering/interacting with the user-submitted post and can send the responses from these three third party responders from either the company's own channels or other administrator designated channels.

In this example, if the content of the user-submitted post may be critical to either the positive or negative image of the company, or could result in a larger amount of sales if conversation were to a dialogue was continued within the thread including the user-submitted post, an administrator or environment 100 can increase the stickiness rating of the user-submitted post or thread. By assigning a higher stickiness rating to the user-submitted post or thread any additional user-submitted posts in the thread can be automatically be moved to a top of the classification queue or alternately if the administrator chooses, directly into the “Need Response” queue. As described herein, the environment 100 can be programmed and/or configured to remove and/or omit any user-submitted posts that are responses added to the thread by responders. Since only user-submitted posts as opposed to responses from responders are effected by the stickiness rating, any posts from responders will not receive a stickiness rating; thereby leaving only new user-submitted posts from users that are added to the thread or related to the thread to be impacted and promoted by this process of generating stickiness ratings. By adjusting the position of the user-submitted posts in the prioritization and classification queue based on assigned stickiness ratings, responses to sticky user-submitted posts and threads can be drastically expedited. This can advantageously facilitate quick, efficient, and/or effective responses to important threads which are critical in both managing a crisis from a public relations perspective and amplifying a viral sales opportunity when found.

In exemplary embodiments, the user interface 150 can be programmed and/or include configured to provide one or more graphical user interfaces (GUIs) 152 through which an administrative user and/or a responder can interact with the environment 100. The GUIs 152 displayed to administrative users and/or responders can include data output areas to display information to the responders and data entry areas to receive information from the responder. For example, one or more of the GUIs 152 can display the user-submitted posts, and information (e.g., metadata, user data, source metrics, etc.) associated therewith, to the responders via the data outputs and the one or more responders can formulate responses to the user-submitted posts via the data entry areas. Some examples of data entry fields include, but are not limited to text boxes, check boxes, buttons, dropdown menus, and/or any other suitable data entry fields.

In exemplary embodiments, the data output areas of the GUIs 152 can display the user-submitted posts according to their classification and/or priority. As one example, the user-submitted posts for each classification can be displayed in a queue or list in which the user-submitted post with the highest priority is displayed first in the queue or list. In some embodiments, the queue or list can be truncated to display a specified quantity of user-submitted posts (e.g., five posts having the highest priorities at an instance in time). The display output areas can be dynamically updated such that, as the user-submitted posts 104 are received by the user interface 150, the user-submitted posts 104 can be inserted into the queue or list based on their assigned category and/or priority score relative to the priority scores of the other user-submitted posts in the queue or list. In some embodiments, different responders can view the same user-submitted posts such that the responders can pull the user-submitted posts from a common pool of user-submitted posts. In some embodiment, different user-submitted posts can be displayed by a GUIs 152 based on an identities of the responders accessing the GUIs 152.

In some embodiments, the data output areas of the GUIs 152 can display a thread of posts (e.g., a sequence of posts) on a source with the post for which a response is to be generated so that the responder to the post can have a context within which the post was submitted.

In exemplary embodiments, a thread of messages, which includes an original user-submitted post from the posting user as well as responses from other users (including responses posted independent of the system), can be displayed to the user interface in a “Classify” view and a “Need response” view. In some embodiments, other external/unknown users will respond to a user-submitted post as effectively as a company representative would/could. In this case, a responding entity (e.g. a company utilizing the environment 100) may wish to not duplicate a response to avoid repetition or reduce costs and time expenditures. To ensure that a duplicate response is not generated, the user interface 150 within which the thread is displayed can include an “Already Answered” button to allow any responder who is capable of responding (who has properly received permissions from the administrator) or any administrator to re-classify a user-submitted post which is waiting for a response from within the environment 100 as “Already Answered,” and in doing so allows the responding entity to avoid generation of a repetitive response and move on to another question that is waiting. This approach advantageously increases the efficiency of the responders and of the environment 100 overall.

The user interface 150 can also provide one or more GUIs 152 that enables an administrator of the environment 100 for a company utilizing the system to visualize which social properties (target pools or social networks overall) have queued user-submitted posts waiting for responses and which do not. The GUIs 152 can allow the administrator to view queued statistics on a per target pool, per social media platform basis, or can allow the administrator to view statistics per individual video, photo, folder or post within a source. Statistics can also be rendered/viewed in graph form to track progress over time.

In some embodiments, the GUIs 152 provided for the administrator can allow the administrator to set a specified minimum number of characters that must be included in a response submitted a responder. The specified number of characters can be associated with a responder pool or group and/or can be associated with individual responders. The environment 100 (e.g., via the posting engine 170) can enforce the specified minimum and can prevent responses from being sent that do not satisfy the specified minimum set by the administrator. In some embodiments, the administrator can specify additional and/or different criteria for responses on a per responder or per responder pool or group basis by accessing the responders individual account or the responder pool parameters, respectively.

In some embodiments, the environment 100 can be accessed from an external user interface that is programmed to interact with the environment 100 (e.g., a user-interface that is not integrated with the system). In these embodiments, the user interface 150 of the environment 100 can generate and transmit a social feed to the external user interface that includes a list of actions that may be of interest to the current responder, such as friends' actions, user-submitted posts that have been classified and found to be well suited to the responder, posts that have been classified and found to correspond to the interests of the responder, and the like. The social feed can be provided to responders using an external user interface to improve the responder experience and/or encourage additional interaction with company promoted content. The more interactions each responder has with user-submitted posts, the more responses are posted to user-submitted posts that have been classified and/or prioritized by the engines 130 and/or 140.

In some embodiments, the social feed can look similar to an instagram feed, friends comments can appear in the feed as can user-submitted posts that are un-answered and well matched to the specific responder for which the feed is generated based on matching variables that match the content of the user-submitted posts to the interests of the responder (or that match the content of the user-submitted posts to topics that the responder has interacted with before). Matching variables include, but are not limited to keywords, users followed as friends, users whom the current user has interacted with in the past, users who like pages or companies that the current responder also follows/likes, and any other suitable measurable user or user history based meta data associated with the user-submitted post and/or the responder.

In some embodiments, the environment 100 can be configured and/or programmed to provide incentives for responders to interact with the environment 100 and/or respond to user-submitted posts. For example, the user interface 150 can be programmed and/or configured to distribute virtual badges, online coupons, product/goods, rewards, and the like to responders. For embodiments in which the user interface 150 distributes social feeds, the user interface 150 can insert the incentives (e.g., badges, coupons, etc.) into the social feed. The incentives can be used to further encourage user interaction from responders. For example, badges can be offered to responders for successfully answering a user-submitted post (or a specified quantity of user-submitted posts), when a user thanks the responder for the response, when the responder reaches a certain mile stone (e.g., a specified quantity of responses posted, etc.). Other incentives can be utilized for additional levels and achievements and the incentives are not limited to simply responding to user-submitted posts.

When the incentives are provided in the form of badges, the badges can be shown to the responder only or to the responder and the responder's contacts in addition to being visible in the responder's own profile when viewed publicly or privately. A company utilizing the environment 100 can also choose to give incentives along with the badges. For example, a company can configure the environment 100 to send a user a coupon or gift code (for use online on a website, webstore or other online property) or may choose to actually send a physical offer, product or incentive to the responder who earned the example badge to encourage continued interaction.

Badges are envisioned to be used for any or all responder groups. Even company employees who act as responders for the company utilizing the environment 100 may be encouraged using virtual badges or other incentives so the use of these features is not limited to any one specific responder groups. By incentivizing efficient and highly effective responders a higher degree of effectiveness can be created by the community as a whole and higher levels of user engagement can be maintained over a longer duration of time without loss of interest.

The distribution engine 160 can include a responder selection module 164 and a user-submitted post distribution module 166. The distribution engine 160 can be programmed and/or configured to provide the user interface 150 with the filtered, prioritized, and/or classified user-submitted posts according to a distribution criteria 162. Responses to user submitted-posts can come from any number of channels, such as channels/accounts owned by companies using the environment 100, channels/accounts owned by individual users, channels/accounts owned by unaffiliated or affiliated entities, and the like. Rules can be specified in the distribution criteria, which can be incorporated into the target pools, to determine which responders have access to which individual company channels, which responders have access to reply from their own channel only, which responders may reply from either the specified company channel(s) or their own channel. These rules can be set on a per Target Pool basis.

Since a response can promote the given channel/account from which the response came, responses to “how to” questions may best promote a “How To” video channel. Different manual or automatic classifications of comment content type can be selected with the use of previously described target pools (automatically selected by specified rules) for answering/posting by one company owned channel instead of another for promotional effectiveness or other reasons or by a responder's own channel if that is most effective as deemed by an administrator of the environment 100.

In exemplary embodiments, replies can be posted, for example, by:

A. From company channel/account.

B. From alternate company channel/account (categorized)

C. From 3rd Party User's channel/account

The channel from which a responder responds from can be manually changed by the administrator, or the environment 100 (e.g., via the posting engine) can change the responder's group/pool/status which can result in their responses being posted through a different channel.

Since posting through a company channel can be higher risk, the environment 100 can be programmed and/or configured to allow only more skilled responders to post responses from the company channel. In situations where a new responder is added and must be trained, many times it is valuable to allow their responses to come from their own channel, or an alternate company channel until they score well enough to respond from the official company channel.

In one example, on the company's own YouTube channel, a message response posted from the companies own channel, onto one of the company's own channel videos can be highlighted by the YouTube system. This may be beneficial if the response is positive and sets a good example/precedent or follows/is aligned with the companies ideals/goals. However, inexperienced responders who can be more likely to comment incorrectly could publicly exacerbate an issue were they to respond from the company's own channel, for this reason these responders can be more effective and carry less risk to the company were they to respond from their own YouTube channels.

In certain instances an administrator of the environment 100 may also want certain responses that are coming from independent 3rd party responders to come from one channel or another once a performance score or thresh hold is met. Settings are available to do this manually per responder or to automatically re-classify a responder into a higher level responder pool/group with different privileges and response channel use.

In exemplary embodiments, the distribution criteria 162 can be used by the distribution engine to select responders that should receive the user-submitted posts and to distribute the user-submitted posts to the selected responders. In some embodiments, all, some, or none of the user-submitted posts are displayed in one or more GUIs to a single responder, a group of responders, or all responders to allow the responder(s) to access and interact with the user-submitted posts. In some embodiments, the distribution criteria 162 can be specified such that each responder can be granted rights/permissions to access and/or interact with user-submitted posts based on information about the responder. For example, the distribution criteria 162 can allow a responder to access and/or interact with all users-submitted posts, only positive user-submitted posts, only negative user-submitted posts, only user-submitted posts having a specified range of priority scores, and the like. In exemplary embodiments, responders can be employees of a business entity utilizing the environment 100, employees of third party business entities bidding to respond to posts, persons unaffiliated with the entities (e.g., crowd sourcing), automated software-based programs executed by a computing device, and/or other suitable responders.

The responder selection module 164 can maintain information about responders including an availability to respond to user-submitted posts, knowledge (e.g., about an entities product offering, an industry, technical aspects of a product offering), experience responding to user-submitted posts, technical background, interests, occupation, reputation, rating, conversion rate (e.g., likelihood a responder from the responder resulting in a sale), an average response time, and/or any other suitable information about the responders. In some embodiments, each time a responder responds to a user-submitted post via the environment 100, the responder information for the responder can be updated accordingly.

Each responder has responder information maintained by the responder selection module 164 can be rated based on the information about the responder and/or previous responses generated by the responder. The responder rating can be generated based a quality review of the responder's responses, the type user-submitted posts being responded to by the responder, user-submitted posts posted in response to the responses generated by the responder (response-to-response scoring), and/or any other suitable information. In some embodiments, a response from a responder can be reviewed and scored before the response is posted to the web page from which the user-submitted post was received (e.g., a YouTube channel or video page, a social media site, or any other web page allowing user-submitted posts). In some embodiments, a response from a responder can be reviewed and scored after the response is posted to the web page from which the user-submitted post was received.

In some embodiments, response-to-response scoring can be used to rate a responder and can be calculated, for example, based on the type of responses a responder receives after posting a response to a user-submitted post; either from the user that originally submitted the post or from a secondary user (e.g., a user other than the original submitting user). For example, when a responder posts a response to a user-submitted post, the user (or other users) will respond to the responder's post. These secondary responses (e.g., user responses to responder posts) can be a valuable indicator regarding the performance of the responder. In exemplary embodiments, a secondary response can be used to score the response from the responder based on the content and/or type of the secondary response posted. For example, secondary responses can be categorized as positive (e.g., a post thanking the responder or affirming receipt of the response), a follow-up question (which can be distributed to the responder that answered the original user-submitted post), negative, and/or can be categorized according to any other parameters. A negative secondary response can be an indication of poor responder performance and/or poor target of user-submitted posts to which responders are responding. As described herein, a user rating can be calculated for the submitter of the secondary response and an affiliation of the user that submitted the secondary response can be considered for scoring the responder based in the secondary response. A weighting can be applied to secondary response based on the user rating and/or affiliation to adjust for inconsistent users and/or poor targeting.

In some embodiments, the responder selection module can rate available responders based on their likelihood to respond to a user-submitted post within a specified amount of time, a quantity of responses the responder generated, a quality of the responses generated by the responder, brand affiliations (e.g., who does the responder follow or like on social media sites, identified by key words used in the responses), and/or based on any other responder information. In some embodiments, the responder selection module can assign high priority user-submitted posts to the responders with highest rating.

In some embodiments, responders employed by a company utilizing the environment 100, associated with the company, and/or third party responders can be grouped into different responder pools and referred to as different assets based on their collective skills/capacity. The environment 100 is configured to monitor responder performance metrics to allow administrators to create rules to include responders that meet a specified criteria on a per responder pool basis.

For example, when an administrator for the environment 100 wants to create a responder pool that includes responders who generate responses quickly to attempt to respond quickly to valuable sales leads that may quickly decay and/or for which responses may become ineffective. Since the environment 100 can maintains a list of the response time per responder (calculated by tracking the time elapsed between the responder first being aware/able to respond to a given message, to the time that responder actually responds to a message) the environment 100 is able to rank responders based on their percentage chance to answer, and also (as mentioned) rank responders on their average response time.

An administrator can create a new responder pool named “Quick Responding Responders” and add an inclusive rule such as “Include all responders who are in the top 10% with regards to their average response time.” The administrator can then select this responder pool as the optimum responders for one or more given target pool(s) allowing the environment 100 to prioritize these responders as the responders to respond to user-submitted posts, and in so doing, generate the fastest responses from the quickest responders.

Other rules can regard a responder's expertise in a topic as indicated by the likelihood of the asking user to then thank the answering responder in an additional comment. An administrator can also create a rule to prioritize responders based on their analyzed performance regarding one subject or another. Further, an administrator can create a rule including responders who have the most experience, or the least experience, to group those responders into specific groups and apply permissions to the responders on a per responder pool basis.

The distribution module 166 can distribute user-submitted posts to the selected responders. For example, in an exemplary embodiment, the distribution module can distribute the user-submitted posts to the user interface 150 with instructions identifying which responder or responders have been selected to respond to the posts, and the user interface 150 can be programmed and/or configured to display the user-submitted posts via the GUIs 152 such that a responder interfacing with the environment via the user interface 150 can only view user-submitted posts assigned to the responder via the GUIs 152 accessed by the responder.

In some embodiments, the responder(s) for the user-submitted post(s) can be selected, and the user-submitted post(s) can be displayed to the selected responder(s), based on the distribution criteria 162 that uses the availability, knowledge, experience, reputation, past performance, and/or rating associated with the one or more responders. As one example, highly rated responders can be authorized to respond to high priority comments and lower rated responders can be authorized to respond to lower priority comments. The distribution engine 160 can be programmed to instruct the GUI 152 to display the high priority user-submitted posts to the highly rate responders and can be programmed to instruct the GUI 152 to display the lower priority user-submitted posts to the lower rated responders.

As another example, a new responders can be permitted to respond to lower priority user-submitted posts and more experienced responders can be allowed to respond to user-submitted posts having a higher priority so that important or valuable user-submitted posts are reserved for more experienced responders.

As another example, responders with sales experience can be authorized to respond to user-submitted posts related to sales inquiries (e.g., posts assigned to a sales category) and responders with technical backgrounds can be authorized to response to comments related to technical inquiries (e.g., posts assigned to technical inquiries category). The distribution engine 160 can be programmed to instruct the GUI 152 to display the user-submitted posts related to sales inquiries to the responders with sales experience and can be programmed to instruct the GUI 152 to display the user-submitted posts related to technical inquiries to the responders with a technical background corresponding to the technical inquiries.

The responder selection module 164 can select responders according the distribution criteria 162 such that responders are selected based on, for example, a responder rating, an assigned category of a user submitted post, a priority of a user-submitted post, user information of the user that submitted the user-submitted post, content of the user-submitted post, responder information, and/or based on any other suitable information. The responder selection module 164 can select a specific responder and/or a group of responders to respond to a user-submitted post. In some embodiments, a responder that has received a post for response, can escalate the post to another responder. For example, a responder can return the post to the distribution engine 160 and can instruct the distribution engine 160 to reassign the post to a responder that has a higher responder rating, a particular expertise required/desired for responding to the post, and the like.

In some embodiments, the responder selection module can determine the extent to which responders have previously responded to similar user-submitted posts by determining whether the content of the user-submitted posts is similar to user-submitted posts previously responded to by the responders. As one example, the responder selection module can select the highest-rating responder that has previously responded to the most similar user-submitted posts and/or previously responded to similar user-submitted posts with the highest quality rating. As another example, if a current user-submitted post is similar in content to a previous user-submitted post previously responded to by the highest-rated responder, the responder selection module can determine if the next highest-rated responder has previous responded to a previous user-submitted post having similar content. This process can continue until the responder selection module identify the highest-rated responder that has not previously responder to user-submitted posts having similar content to the current user-submitted post. If all responders have previously responded to a similar user-submitted post, the responder selection module selects the highest-rated responder.

In some embodiments, an automated response can be generated when it is determine that the user-submitted posts requests preprocessed information based and the content of the user-submitted post. As one an example, when the user-submitted post requests a customer service phone number, an address to a business entity's location, specifics about some of the content on a source to which the user posted the post, and the like, the environment during the filtering, prioritizing, and/or classification processes can analyze the content of the user-submitted post to instruct the distribution engine to generate an automated response to the user-submitted post. In one exemplary implementation, the environment can maintain information video and/or audio information from a video embedded in a YouTube video page, such as an artist, song title, album title, actor, professional athlete, and/or any other information corresponding to the video and/or audio. When a user-submitted post requests this information (an artist and song title of a song used in a video on a video page in YouTube), the distribution engine 160 can access the information maintained by the environment 100 and can generate a response to the user-submitted post that includes the information (e.g., the artist and song title).

As another example, the distribution engine 160 can be programmed and/or configured to allow an administrator to specify that a certain percentage of user-submitted posts for which preexisting responses can be pulled from a database of responses to past posts (e.g., when the current user submitted post substantially matches a previously response to a past post). Administrators may create rules related to specific target pools and the distribution engine 160 can be programmed to implemented the rules to determine when (if at all) database re-answering may be used, as well as how it is used, which responses in the database can be re-used, and from which responder they will be publically posted. Since all answers from all responders can exist within the database, the responder identified as posting the preexisting response may be different from the responder that originally posted the response the first time. The identity of the responder from which the automated response is posted can be, for example, the company utilizing the system, a secondary company used specifically for this type of response, a random selection from a responder pool, and/or from a third party responder.

In exemplary embodiments, the environment 100 can be configured to process and distribute user-submitted posts to responders as they are received by the environment 100. If there are responders available that are waiting for user-submitted posts to respond to, exemplary embodiments of the environment 100 distribute user-submitted posts as they are received by the environment 100. As one example, in some embodiments, the environment 100 can be programmed and/or configured to provide a user-submitted response to a responder after the post has been filtered, prioritized, and/or classified. As another example, in some embodiments, the environment 100 can be programmed and/or configured to bypass the filtering, prioritization, and/or classification of user-submitted posts when responders are waiting to respond to posts (e.g., a responder currently does not have any posts in the queue).

In some embodiments, the distribution engine 160 can be programmed and/or configured to allow bidding for the ability to designate a responder to a user-submitted post. For example, third parties can submit electronic bids based on the third parties' perceived value of selecting a responder to respond to the user-submitted post of a given priority score based on the priority criteria and/or the perceived likelihood that the response will impact a purchasing decision of the user that submitted the user-submitted post. In some embodiments, the highest bidder is given the right to select a responder to the user-submitted post.

In some embodiments, the user information maintained by the environment includes account information of a user that submitted a post. As one example, a user can subscribe to a YouTube channel associated with the business entity utilizing the environment 100 so that the user information can include a username of the user. The user information can be linked to an online shopping account associated with the business entity. When the user makes a purchase, the environment 100 can review the user information and search for previously extracted user-submitted posts to determine if the user interacted with the business entity prior to making the sale and to determine which responder the responded to the user-submitted post from the user. When a responders response to a user-submitted post is followed by a sale, the sale can be utilized to determine a rating for the responder.

In some embodiments, a third party's selected responder (who can either associated with the third party or unassociated with the third party, but who meets a third party's selection criteria) can be scored based on a distribution criteria 162 and the winning bid can be calculated based on a formula that considers both the skills and expertise of the proposed responder, and the bidding amount from the third party, with the right to designate the responder being granted to the bidder with the highest combined score determined by the bid amount and likelihood of produce a positive and helpful response for the user that submitted the user-submitted post. Some factors for scoring a bidder include, for example:
Bidder Reward (e.g., pays less) for askers who are local in proximity
Bidder Reward (e.g., pays less) for quick response
Bidder Reward (e.g., pays less) for users who “like”, “subscribe” or “follow” the company's social media channel
Bidder Reward (e.g., pays less) for neighbor users (friends that have purchased or friends that have liked/interacted with a given brand or key term)
Bidder Premium (e.g., pays more) based on views/comments per day
Bidder Premium (e.g., pays more) based on user value or comment value calculated based on specified criteria
Bidder Premium (e.g., pays more) for exclusive answering (meaning multiple bids for a single comment would not be accepted)
Bidder Premium (e.g., pays more) for users who are likely to share with other users in a social network
Bidder Premium (e.g., pays more) for low Score/poor previous answers based on user feedback for a category of users or similar/overall questions

Different sources (e.g., web sites and sub site locations) can have different dispositions and affinities to particular companies or products and certain responders can be better oriented to respond (and have their identity displayed) on certain source (e.g., websites) or certain locations within an individual source (as classified by an administrator or operator of the environment 100 or as determined by the environment via, for example, automatic keyword analysis classification processes). For example, within YouTube, a user of the environment 100 may be a company that maintains its own YouTube channel. Most independent users on this channel may be sympathetic to the companies beliefs and products. For this reason, less experienced responders (who may offend more hostile users) could be qualified to respond to a user-submitted post on the company's own You-Tube channel because the users reading the posted response may be sympathetic to the company and to the sentiments held in the response. The distribution engine 160 can be programmed and/or configured to match groups of sources (i.e. source pools) to groups of responders (i.e. responder pools) having responders for responding to user-submitted posts from the source pools positively.

As an example, a user of the environment 110 can own a channel on YouTube and the company's competitors also own a channel on YouTube. Both channels can support similar content, but the user bases of these channels can have very different biases and ideals. The users on the competitors channel may be biased against the company and company's products. Further, these users may be offended if the company responds to user-submitted posts on the competitors channel. In these circumstances, it may be less than ideal for a response to a post on a competitor's channel to come from the company's channel. Another option can be for an independent third party responder and/or someone is not known to be affiliated with the company, but whom shares sympathies toward the Company and the Companies products, to respond to a user-submitted post on competitors channels. An option can be if a responder, who is positively predisposed to the company and is an experienced responder (with a large quantity of prior positive responses posted via the environment) responded to a post on a competitor's channel, as it may be likely to provoke further debate with users predisposed to the competitor with the objective that an intense debate would be more effectively handled by experienced responders who may make fewer mistakes.

Both previous examples illustrate instances where the exact source location of the incoming comment, and the pre-disposition of the users who submit post to this location, changes the most effective way of interaction. For this reason, one way to ensure effective selection of a responder can be to not only rate and group responders into responder pools but also to rate and group source locations into source pools which can be manually and/or programmatically classified and/or prioritized based on their polarity (bias) to a given company channel. These source pools can he then be manually or programmatically matched to the best possible responder pool.

In some embodiments, a conversion value could be assigned manually and/or programmatically to a given source pool that includes different source locations (e.g., URLs), groups of source locations, or groups of source locations that have different, slightly different, or substantially similar value rating on a given scale. Programmatically priority could be given to those source locations with a source pool with the highest value rating, or those with the highest value rating and highest polarity to a company, or weights could be assigned per value. Any amount of measurable or estimable parameters can be assigned to a source pool or to individual source locations or groups of source locations in a source pool, and any parameter can be given any amount of weight to generate a best possible priority for incoming posts and a best possible chance to match those posts with a responder from a most prepared and effective possible responder pool, as selected or specified by the company using the environment 100 to respond to posts or as selected by a high bidder for a given matched pair (source pool to responder pool).

An example source pool can include, for example, different website URLs, URLs of individual web pages, and/or groups of web pages inside of a website that all share a likeness in terms of a given list of attributes or as manually designated by an operator of the environment 100 (e.g., the company). These URLs can be from a singular Social Media or Blog platform (e.g., FaceBook, Turnblr, or Twitter) or from any number of different social media/blog platforms or applications that the company believes share similar traits (e.g., FaceBook and Twitter).

In some embodiments, if there has been no engagement or response to a user-submitted post that has been distributed to one or more responders within a specified time period, the distribution engine 160 can be programmed and/or configured to redistribute the user-submitted post to one or more other responders. For example, the distribution engine 160 can distribute a user-submitted post to a responder in a responder pool and if the responder fails to select the user-submitted post for response and/or respond to the user-submitted post within the specified time period, the distribution engine can redistribute the user-submitted post to another responder in the responder pool. If all available/online responders in a responder pool have been given an opportunity to respond, but there has been no engagement or response to the user-submitted post, the distribution engine can be programmed and/or configured to redistribute the user-submitted post to one or more responders in another responder pool, e.g., a responder pool associated with a given target pool from which the user-submitted post was distributed. In some embodiments, the responder pool can be the next highest rated responder pool associated with the target pool.

In exemplary embodiments, engagement can refer to any sort of interaction with the distributed user-submitted post (e.g., clicking an entry box to start typing a response, clicking to view asking users profile, clicking to view asking users message history, etc.). A responder can engage a user-submitted post from the user interface of the environment 100 and/or can engage the user-submitted post from a user-interface that is external to the environment 100.

As a non-limiting example, when a new user-submitted post is classified as “Needing Response”, the environment 100 can select a target pool “A” which has the highest priority for this post. The environment 100 can refer to a list of rankings (either previously compiled or compiled when needed) for each of the responders or responder pools associated with the target pool “A” to determine which responder or responder pool has the highest rating (e.g., to identify the best chance of a successful response). When the distribution engine 160 identifies the responder, the distribution engine 160 can check to see whether the responder is logged in, available, not idle, or otherwise likely to engage and respond to the user-submitted post. In some embodiments, the distribution engine 160 can encourage interaction for a responder by sending a push notification to potentially prompt the responder to interact (even if that user is not directly logged into the environment 100). Once a notification is sent, the distribution engine 160 can start a prospector timer. After a specified amount of time has elapsed the responder engages and/or responds to the user-submitted post, the distribution engine 160 redistributes the user-submitted post to the next highest scoring responder associated with the target pool “A” and the prospector timer restarts. This process can repeat for as long as necessary to find a responder who will answer the prompt. In some embodiments, multiple responders can be prompted while only one is allowed to answer (e.g., once the first responder engages the user-submitted post other responders are unable to engage the user-submitted post). In some embodiments, the distribution engine 160 can allow multiple responders to engage and respond to the user-submitted post at the same time. In some embodiments, all responders responding to the user-submitted post can see the responses other generated by the other responders and the responders can interact with each other while responding to the user-submitted post. In the present example, the distribution engine 160 operates to identify responders sequentially such that when the distribution engine 160 identifies a responder and the responder engages and/or responds to the user-submitted post, the distribution engine 160 considers the distribution of the user-submitted post a success as soon as the responder engages and/or responds to the user-submitted post, the distribution engine 160 does not continue to look for a responder for the user-submitted post (e.g., no longer prospects for a responder). As described herein, the environment 100 and/or administrator can designate that a user-submitted post receive multiple response. For these user-submitted posts, the distribution engine 160 can be configured to prospect for multiple responders to the user-submitted post simultaneously and in parallel.

In some embodiments, after a responder has engaged, but has not responded to the user-submitted post, the distribution engine 160 can be programmed and/or configured to utilize a secondary timer to make sure that the responder does not go idle before sending a response. If the secondary timer expires before a response is provided by the responder, the distribution engine 160 can be programmed to identify another responder for the user-submitted post. In some embodiments, the distribution engine 160 can be programmed and/or configured to withdraw the idle responders ability to respond to the user-submitted post. In some embodiments, the distribution engine 160 can be programmed and/or configured to allow the idle responder to respond to the user-submitted post when the idle responder returns from idle.

The target pools and responder pools can function to allow an administrator to prioritize different types of user-submitted posts and match those different types of user-submitted posts to specified groups of responders in responder pools to facilitate the generation of efficient and/or effective responses. From time-to-time, a quantity of user-submitted posts extracted by the extraction engine 110 for a company utilizing the environment 100 may overwhelm the company and/or overly burdensome of the responder groups such that the responders are unable to quickly and efficiently respond to the queue of user-submitted posts within a given target pool. In these circumstances, it may be more beneficial for a different responder group or pool that can quickly respond to the user-submitted posts even though the responders in the difference group or pool may not be ideally suited for preparing response to the user-submitted posts from the target pool. In exemplary embodiments, this can be achieved by setting additional responder pools as backup to the selected responder pool to provide the distribution engine 160 with an alternate group of responders (which can be specified by administrator on a per target pool basis). Using this approach, it can be possible to quickly respond to user-submitted posts to generate desirable results for cases where the time elapsed between when the user-submitted post is posted and when a response is posts may greatly influences the outcome (e.g., an effectiveness of the response). In some embodiments, responders can be individually added to responder groups as opposed to being selected conditionally or individually.

By using responder pools, as described herein, an administrator can prioritize in-house, company paid responses, versus external unpaid cloud based responses based on scoring/effectiveness and/or based on the number of waiting responses/the effectiveness of the “company paid” responder group (i.e. if the paid company employees in the company “Paid Responder” pool are not keeping up with a specified percentage of all user-submitted responses in for a specified time period (as calculated automatically by the distribution engine 160) then user-submitted posts with a given (potentially lower) overall value score can default to cloud based responders to ensure that quick response time is achieved. Alternately, a user-submitted post of any score may pass to responders as it is determined that the primary responders selected for the user-submitted post are unable to respond within a given time period. In some embodiments, for example, an administrator of the environment 100 may prefer company employees be given 5 minutes to respond to a comment. If no response is written and sent within 5 minutes, the user-submitted post will be passed to company unpaid associates to respond, and if no response is provided in 5 minutes, the user-submitted post can be passed to 3rd party cloud responders.

In some embodiments, this approach can also be used when a bidding structure is used by the distribution engine 160 to determine which responding entity is given an opportunity to respond to a user-submitted post. For example, a responding entity that initially wins the bid can be given a certain amount of time (which could also be influenced by bid) to respond to the user-submitted post. If the response is submitted, the bid is charged the full amount. In some embodiments, fast responses can receive a discount. If the responding entity that initially wins the bid does not respond to the user-submitted post in the allotted time, the responding entity can be charged a portion of the bid for the granted opportunity to respond and the user-submitted post can be passed to a responding entity that submitted a runner-up bid. Since this bid is now “older”, and the age of the user-submitted post (the time elapse since the post was submitted) may determine a value of responding to the post, the runner-up responding entity may receive a discount on its bid. Responding entities may bid different amounts of money for the opportunity to respond to user-submitted posts of varying ages since the age of the posts can determine a value of the post to the responding entity (e.g., newer posts may provide a higher likelihood that a response will result in a sale).

In some embodiments, a responding entity that is granted an opportunity to respond to a user-submitted by the distribution engine 160 can also enter a “roll over” bid to allow the responding entity to have multiple time periods to respond to a user-submitted post. For example, if a response is not submitted within a specified time, the “roll over” bid can be used to provide the responding entity with an extension of time within which to respond. In some embodiments, the responding entity can designate a first responder group or pool (e.g., employees) for the initial time period and a second responder group or pool (e.g., selected affiliates) for the extended time period. In some embodiments, the “roll over” bid can provide further extensions of time. For each extension of time, the responding entity that wins the bid can designate the same or different responder groups or pools. A response submitted with the initially time period and any extended time periods can result in a charge to the responding entity. If the responding entity fails to submit a response to the user-submitted post within the allotted time, all or a portion of the bid can be collected (to encourage fast action and ensure an acceptable wait time for responses to user-submitted posts). In the event that the responding entity fails to respond, the responding entity with the next highest bid (which may take into account a responding entity quality score) can be given an opportunity to respond to the user-submitted post by the distribution engine 160. As described herein, a responder quality score can be factored into a determination of which responding entity wins the bid such that a winning bid for a known high quality responding entity may be lower than a bid submitted by an inferior responding entity to encourage responding entities to leverage resources to help respond to user-submitted posts.

The posting engine 170 can be programmed and/or configured to post the response to user-submitted posts (i.e. by transmitting the response to the source from which the user-submitted post originated). After a response to a user's post has been posted, the posting engine 170 can notify the user who submitted a post that the post that a response has been posted. In some embodiments, the posting of responses by the posting engine 170 back to the data source from which the user-submitted posts were extracted can be immediate or delayed. The posting engine 170 can be programmed and/or configured to utilize a posting criteria 172 to determine whether the responses to the user-submitted posts should be posted immediately or after an occurrence of an event. For example, the posting device 170 can be programmed to post formulated responses to user-submitted posts after one or more event occur (as defined by the posting criteria 172), such as:
Expiration of a specified delay period.
Expiration of a delay period that is determined based on an average number of posts to the web page divided by 24 hours.
A subsequent (e.g., the next) user-submitted post posted to the web page.
A subsequent user-submitted post submitted to the web page followed by an expiration of delay period.

The posting criteria 172 can facilitate an “always active” response mechanism in which responses to each web page can be separately queued. Responses in a queue for a web page can be posted from the queue to the web page, where the timing with which each response is posted from the queue is determined by the posting criteria 172 associated with the web page. As one example, in some embodiments, user-submitted posts to a web page (e.g., an entity's YouTube channel) can be received throughout the day and the responders can receive, review, and respond to the user-submitted posts based on the classification and/or priority assigned to the user-submitted posts. To prevent flooding the web pages with responses, the posting engine 170 can delay posting the responses until the posting criteria 172 is satisfied. By controlling when responses are posted to a web page, exemplary embodiments of the present disclosure can advantageously improve the likelihood that users will submit more posts to the web page because users are not likely to submit posts when there are multiple responses in a short period and/or when there has been little time since the last response. Using the posting criteria 172, the posting engine 170 can advantageously spaces out when responses are posted to provide a consistent presence of responders for a web page, rather than posting batches of responses together.

In exemplary embodiments, the environment 100 can be programmed and/or configured to provide a performance comparison between business entities based on an analysis of the priority scores for user-submitted posts on sources associated with the business entities. The comparison can provide trending data regarding public opinion of the business entities. The relative comparison can be provided to business entities utilizing the environment 100 to indicate the success of one business entity relative to another. In some embodiments, a business entity can monitor a performance of a competitor via the environment 100 based on the performance comparison to estimate their position in the marketplace.

In some embodiments, the environment 100 can be programmed and/or configured to determine a frequency with which a user is submitting posts to a source associated with a business entity utilizing the environment 100 and/or the type of posts being submitted by the user thereto. The environment can automatically delete user-submitted posts from the user when they are posted if it is determined that the user is posting too frequently and/or the type of post is undesirable to the business entity. For example, the environment 100 can select a quantity of user-submitted posts from a user required to occur within a specified time period before the user's posts are deleted and can specify a duration (e.g., a day, week, month, etc.) or quantity of posts (e.g., the next five posts) for which the users posts will be deleted before the user can continue to post to the source.

In some embodiments, where many responders may be responding to user-submitted posts via a graphical user interface provided by the environment 100 and/or the responders' traditional web location interfaces, the environment 100 can have an advanced record of which responders are integrated in the environment 100 and which responders are not. By comparing responders who are a part of the environment 100 to responders who are not integrated into the environment 100, the environment 100 can remove responses from the responders from target pools including user-submitted posts waiting to be classified. In this manner, efficient classification can be achieved by eliminating the processing of user-submitted posts from known responders (i.e. responses from responders).

The environment 100 can also track responses (for addition to a responder's response history) posted to a social network service from other user interfaces capable of creating/posting responses (e.g., external to the user interfaces provided by the environment 100). For example, there can be four responders and one administrator of the environment 100. The administrator can specify in the environment 100 that the first three responders (A, B, and C) should use their own screen names when posting responses (i.e., responses posted from their unique account names, not a company account name). The fourth responder (D) can be authorized to respond to user-submitted posts using the company's own channel and authorized to classify new incoming user-submitted posts also on the company's own channel(s) (Original Skateboards for example).

Responders A, B, and C can each respond to individual user-submitted posts that were marked (by Responder D, for example) as needing a response on a single video or social content post, each from their unique user account names with responding done from the user interface provided by the system. Responder D then also responds to a separate user-submitted post on the same video before returning to a “classify” portion of the user interface.

When responder D begins classifying she may not see the responses from responders A, B, or C. Because responders A, B, and C responded using the user interface provided by the environment 100, the environment 100 can record their responses and can disregard their responses when listing the user-submitted posts that need to be classified. This is because these responses are already coming from the environment 100 and the responses are already recorded and associated with each responder's account by the environment 100. Since the environment 100 does not re-classify these responses, in some embodiments, the environment 100 can save time during classification.

In another non-limiting example (using the same four responders A-D), responders A and B use the user interface provided by the environment 100 to respond to user-submitted posts, while responder C uses a traditional YouTube interface to post a response to a user-submitted post that she found while navigating a video in her browser (e.g., external to the interface provided by the environment 100). The video can be part of a target pool and can be actively queried by the environment 100 to extract new user-submitted posts and analyze the new user-submitted posts. As in the last example, responder D can function as the administrator to classify incoming user-submitted posts. Normally, as in the last example, all three responses (from A, B, and C) can appear in an “unclassified” portion of the user interface requiring either manual or programmatic classification. However, as with the previous example, the environment 100 recognizes that responders A and B responded through the user interface 150 provided by the environment 100 and disregards these responses (e.g., does not classify the responses). In some embodiments, the environment 100 can be configured to reduce resources by either checking the user names of responders (e.g., responders A and B) in relation to the responder pools and/or by checking user-submitted posts against the database to determine whether the responses already exist in the environment 100.

Because responder C posted a response from an interface external to the environment 100, the environment 100 has no knowledge of responder C's response. That is, because the external interface is not a part of the environment 100, responder C's comment is not recorded by the environment 100 when it is initially posted to a source location. Eventually, responder C's response can be extracted from the source location as a user-submitted post. When the environment 100 finds responder C's comment, checks the username associated with the post and compares it against responder usernames stored by the environment 100. If the environment 100 matches the username in the post to a stored responder username for responder C, the environment 100 can check whether the post in question (e.g., the response posted by responder C) was posted from the user interface integrated into the environment 100.

The environment 100 can be configured to check to see if the comment exists first instead of second and may use many or a single algorithm/method for determining whether the comment and user are known. In one example the environment 100 compares the posting time stamp/posting time and date to the database and then comparing the text of comments posted in that general vicinity attempts to find a match. By using different programmatic logic the environment 100 can be customized to most efficiently utilize system resources where different target locations may have different requirements.

Upon finding that a post extracted from a source location was posted by known responder C from an interface external to the environment 100, the environment 100 attempts to determine whether the post is itself should be responded to (e.g., whether the post asks a question) or whether the post is itself a response to another user-submitted post (e.g., a question posted by a user). In some embodiments, the environment 100 can determine whether the post is a response by analyzing the thread of a comment/subject line associated with the post and/or by searching for the @ symbol which can indicate a response on some social media networks. In some embodiments, the environment 100 analyzes whether the post from responder C is a stand-alone post or a part of a thread (i.e. a sequence of posts in which responder C's post is a response to another user's post). Upon finding that the user comment is a response to another users post, the environment 100 can check whether the user-submitted post to which responder C is responding is already known by the environment 100 (e.g., extracted from a source location and processed by the environment 100. If the user-submitted post is known, and has been classified as “Needing Response”, the environment 100 can be programmed and/or configured to assume that responder C responded to the user-submitted post (e.g., answered a question) and the user-submitted post can be moved from the “Need Response” category to an “Answered” category, or alternatively, the environment 100 can be programmed and/or configured to keep the user-submitted post in the “Needing Response” category so that the user-submitted post can receive a response from another responder.

By giving an administrator control of how the environment 100 perceives such events it is possible to configure the environment 100 to either be conservative (valuing multiple responses to ensure a correct answer) or aggressive (speeding up the process in order to generate more responses even if one specific question may not be fully answered). While various processes, functions, and/or algorithms have been described with respect to expediting the process of recognizing known environment 100 comments and/or known environment 100 responders, those skilled in the art will recognize that other processes, functions, and/or algorithms can be implemented to reduce resources or expedite recognition known environment 100 comments and/or known environment 100 responders.

In some embodiments, the environment 100 can be programmed and/or configured to facilitate responses from respondents using other forms of responding other than posting a response. For example, responders can respond to user-submitted posts by indicating an agreement with the content of the user-submitted post or providing any other indication that may be available through the source of the post. This alternate form of responding can be as effective as posting a response to user-submitted posts in some circumstances without simply posting a response to create a conversation back and forth. Twitter, for example, allows users to favorite a tweet, which can provoke interaction and potentially start a conversation without transferring posts back and forth between users and responders. Favoriting in Twitter can be an affirmation of the content of the user-submitted post, and as such, can encourage the user to learn more about the favoriting company (or user) who also shares their beliefs. Likewise, Facebook has a “poke” feature in addition to a “like” feature which can be used similarly YouTube grants the ability to “like” a comment, “like” a video or subscribe to a channel. All of the above non-language based interaction methods can be excellent tools for creating a cohesive community.

The environment 100 can be programmed and/or configured to facilitate any available form a responding to user-submitted posts including incorporating the use of any social media services that may have the same or different communication methods. In some embodiments, the environment 100 can utilize this functionality during both the classifying and responding to user-submitted posts so that an administrator or classifying user can exercise non-comment based actions (e.g. respond with a “like”, “favorite” or “retweet”), while classifying, or so that the environment 100 can be programmed and/or configured to indicate that a responder should respond with a non-comment based action.

In the case of twitter and other services where alternate forms of communication exist (e.g., YouTube has a thumbs up for comments, Facebook has a like, and a “poke” feature, tumblr and flickr all have similar features), the environment 100 can be configured to allow a responder to respond using this the favoriting functionality. By allowing for functionality, beyond just commenting, a company or user can more efficiently connect with a give user. In this way a company admin or responder pool user can start a conversation that otherwise might not otherwise be possible and as a result build their supporter base and in some instances those conversations may even result in sales.

Other types of responses can used by responders when responding to user-submitted posts that have been processed by the environment 100. For example, in some embodiments, the environment 100 can be programmed and/or configured to implement re-sharing of other user-submitted posts in response to a user-submitted post from a user. For example, user-submitted posts can be extracted from their sources and some of the user submitted posts can be saved by the environment 100 and used, re-used, or reposted at some later date to the source from which the user-submitted post was extracted and/or to other sources.

As one example, the environment 100 can save a photo posted on Instagram, or similar video/picture sharing services (e.g., Vine, tumblr, youtube etc) and can re-upload the photo to Instagram if the photo shares and/or perpetuates the goals and ideals of a company utilizing the environment 100. In some embodiments, when a company utilizing the environment 100 reposts the post, the company can repost the post to its account at the source. The user that originally submitted the post that is reused will generally be happy because their post will receive more exposure, and the user is usually credited when post is re-posted. The whole process can result in an incentivised/gamified contest to see who can submit a post that will be re-posted. In the case of Instagram, these “Re-grams” (e.g., photos saved and then reposted to a company's Instagram account) are similar to re-tweets on twitter, but the functionality is not natively supported in the Instagram application. The functionality of the environment 100 can be programmed and/or configured to advantageously enable re-posts.

When dealing with Instagram and other similar services (e.g., Vine, Tumblr, Flickr etc), a company utilizing the environment 100 may wish to add user accounts as “Target Pools”. Instagram accounts that are targeted can also show a base PHOTO/Video posted by a targeted user for classification in addition to showing the posted by all users on that photo. In this manner, the actual photo or video content can be classified and potentially re-used in a re-gram or repost. In some embodiments, the environment 100 can including functionality that facilitates contacting administrator to ask permission to repost the photo or video content from either within the environment 100 or external to the environment 100. Alternative functionality can also exists to save photo and/or video content for review by an administrators (or someone else) or to save the photo and/or video content as important to one or more user pools. In this way, content flagged as important can be available for re-transmitted.

In exemplary embodiments, the externally posted media content types can be organized similar to the organization that a traditional web content management environment 100 (CMS) can create. Text, video or photos marked as important can also be selected for use on a website of a company utilizing the environment 100 or on GUIs rendered by an application via an API interface. In other words, the environment 100 can be programmed and/or configured to add additional saving, archiving, and sharing capacity beyond just the sharing and saving capacity natively available to any specific social media service and allows for the easy transition of content on one social media location to another social media location. In this way, important pieces of photo of video media content, even if there is no comment on that content that would specifically require classification or interaction, can be distributed to user pools to provide a significant increase in virility of ideas that are important to a company that utilizes the environment 100.

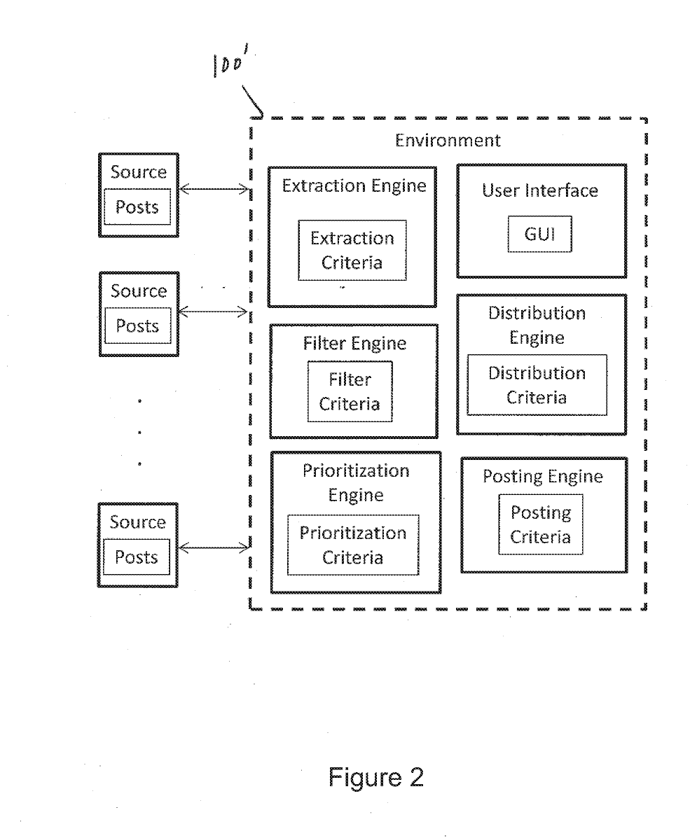

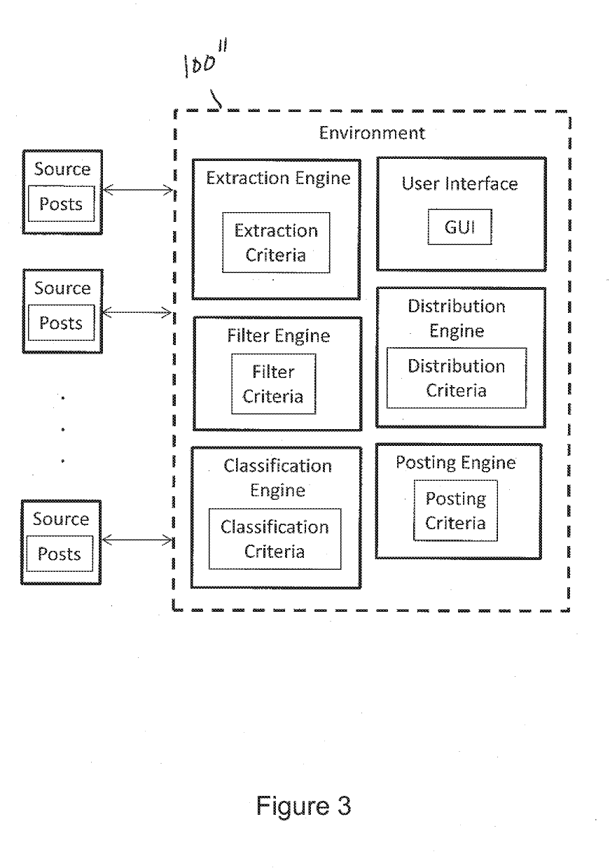

While an exemplary embodiment of the environment 100 has been illustrated with the extraction engine 110, the filter engine 120, the classification engine 130, the prioritization engine 140, the distribution engine 150, the user interface 160, and the posting engine 170 as separate components, those skilled in the art will recognize that one or more of the engines 110, 120, 130, 140, 150, 160, and 170 can be integrated with each other. Furthermore, while an exemplary embodiment of the environment 100 includes the engines 110, 120, 130, 140, 150, 160, and 170, those skilled in the art will recognize that different embodiments can include different combinations of the engines 110, 120, 130, 140, 150, 160, and 170. As one example, FIG. 2 depicts another exemplary environment 100′ that is similar to the embodiment of the environment 100 shown in FIG. 1 except that the environment 100 does not include the classification engine 130 such that user-submitted posts are prioritized, but not classified. As another example, FIG. 3 depicts another exemplary environment 100″ that is similar to the environment 100 except that the environment 100″ does not include the prioritization engine 140 such that the environment can classify the user-submitted posts, but does not actively prioritize the user-submitter (e.g., the user-submitted posts may still be prioritized by default based on a time when the posts were received).

As described herein, the environment 100 can be programmed and/or configured to find user-submitted posts, and then to find responders who can respond to the posts. In some embodiments, the environment 100 can be integrated with and/or can be utilized by a search engine (e.g., Google, Yahoo, etc.) such that queries submitted to the search engine can be processed to return traditional web search results and can also be processed by the environment 100 as user-submitted posts to facilitate a response to the query from a responder as described herein.

In some embodiments, the interface between the search engine and the environment 100 can be an integrated browser extension, such as a chrome or firefox extension. In this instance, a user can type a query into a search box added to their browser by the extension. The extension can then open a google (or otherwise) search engine results window while also generating a window with responses from the environment 100.

In some embodiments, the user interface to the environment 100 can be packaged as an html (5 or otherwise) web app, while the traditional search engine functionality can opened in a separate iFrame or encapsulated window.

In some embodiments, the user interface to the environment 100 can be an executeable file useable on Windows, Mac, Linux, or other suitable operating environment 100s. The executable file can include its own search engine functionality or can utilize pre-existing search functionality from other application executed in the operating environment 100.

The search engine can accept a query, and can process the query utilizing techniques known to those skilled in the art (e.g., to return webpages corresponding to the query). The search engine can also submit the query to the environment 100 for processing and the environment 100 can process the query as a user-submitted post to find which target pool the query falls into based on the query terms.

The environment 100 then follows the rules of that target pool to programmatically determine which responder pool is best qualified to respond to the user-submitted post. In response to identifying the responder pool, the environment 100 can identify whether there any bids from responders in the responder pool to respond to the user-submitted post in the target pool. The environment 100 determines which bid is most advantageous, which can be determined upon execution of an algorithm that assign points based on which responder is likely to provide the fastest response, which is likely to provide the most correct response, and/or based on the bid amounts received. The responder that receives the highest total points can receive the first priority to respond to the user-submitted post. If there are no outstanding bids to respond to the user-submitted post (e.g., the search query), the post can be presented to the most qualified responders as described herein.

If a responder start a response to the post, the opportunity for other responders can be locked to show that a response to the post is currently being composed and to disable the ability of other responders from responding to the post. In some embodiments, as soon as the responder starts a response, the environment 100 can be programmed to notify the user that posted the post that a response is being formulated (e.g., by interacting with the search engine to display the notification). If the responder fails to finish typing the answer within a given time period, the environment 100 can be programmed to remove the lock and allow other responders to respond to the post. In some embodiments, if a responder bid on the ability to respond to the post, the responder can be charged a minimum (no-answer) charge. This charge can encourage responders bidding to respond to posts to provide a response (e.g., where the bidding responder is a company, it can encourage the company to effectively staff and manage their responder pools to ensure that responses are quickly and efficiently provided to query owners). The response(s) to the post from the environment 100 can be displayed to the submitting user alongside the web search results returned by the search engine.

In some embodiments, the environment 100 can be programmed to search a database storing previously generated responses to identify responses that correspond to the query submitted to the search engine and to provide the previously generated responses to the search engine for display to the user. When a user submits a query, the search engine can return a list of traditional (and perhaps exact) results either from its own database or from a partner database (google, bing, yahoo etc) along with the list of previously generated responses. When a live responder is formulating a response to the query via the environment 100, a notification can be displayed to the user (e.g., via the search engine's graphical user interface to indicate that a responder has started formulating a response. For example, the environment 100 provide a notification message “Responder Johnny863 is typing an answer.”

Since the user that submitted the query via the search engine may be reviewing the returned results (e.g. the traditional search engine results and/or the returned previously generated responses), the user can determine whether to stop reading through the returned results and wait for the human supplied response to be provided or to continue reviewing the returned results.

If the responder successfully finishes typing the response, the environment 100 canl automatically post the response to allow the user to review the response. If the right to respond to the query was based on a successful bid, the responder can be charged for the bid price when the response is posted.

In some embodiments, the responder's response to the query submitted to the search engine can contain a universal resource locator (URL) for reference and to encourage connection to a responder's website, social media profile, or online store for the purposes of helping the responder accomplish their goals (be it sales oriented or otherwise).

Upon viewing a response to the query generated through the environment 100, the user can interact with the user interface to perform one or more operations. As one example, the user can indicate that the response provided by the responder did not adequately address the query, in which case the user's query can be resubmitted to the environment 100 for reprocessing and the previous responder will be barred from an opportunity to generate another response to the query. In some embodiments, when a user indicates that the response was not acceptable, if another responder has previously responded the same or similarly query in the past, that responder may be disqualified from responding to the query because the user has already indicated that, in this instance, such as response is not adequate. In some embodiments, the environment 100 can maintain one or more logs to identify users who frequently indicate that a response is unacceptable to allow the environment 100 to take one or more actions when it receives a query from such a user.

If the response provided by the responder is acceptable to the user, the user can choose to acknowledge that fact by clicking an “Answered my Question” link that can be displayed next to the response. In this case, the user that submitted the query can be prompted to optionally return feedback to the responder (e.g., “Say thanks to Johnny863” or “follow his future responses”). In some embodiments, users and responders may send messages back and forth (similar to email/instant messaging) by visiting each other's profiles in the environment 100.

In some embodiments, if the responder bid for an opportunity to respond, the responder can enable an option (and bid on the possibility for some amount of additional cost) to open a direct chat window with the user (e.g., via the search result display interface. The chat window can allow the user to ask additional questions that are related to the original query. When the responder is a company, the chat window can provide an opportunity to directly engage with a potential customer. From a submitting user perspective, it can be easier to re-phrase or format a query via the chat window in direct communication with a responder, rather than having to re-enter the query in the search engine, which can also allow for faster and less resource intensive responses that can improve service and reduce cost for responders utilizing the environment 100. In addition to the chat window, or in the alternative, the environment 100 can facilitate a connection between the user and the responder by phone, video, voice over IP, and the like. In some embodiments, the user submitting the query can choose to pay to establish a direct connection with a responder. The responder could in turn be compensated, perhaps 45% of the query owner paid price in order to encourage experts to host extended dialog with query owners.

An exemplary GUI can be provided by an exemplary embodiment of the user interface 150. The GUI can be programmed and/or configured to present an administrative console to allow administrative operators to change, modify, and/or revise the extraction criteria 112, the filtering criteria 122, the prioritization criteria 132, the classification criteria 142, the distribution criteria 162, the posting criteria 172, a list of responders that can access the environment to responders to user-submitted posts, a list of administrative users that can change criteria and/or other parameters of the environment, and/or to change, modify, or revise other aspects of the environment 100.

The administrative console can display metrics for source being targeted by the extraction criteria as well as suggested sources to target and can provide one or more links to navigate to other GUIs in the environment 100, such as GUIs that display user-submitted posts from the sources, user information and ratings, responder information and ratings, and/or any other information/data that may be generated, received, and/or maintained within the environment 100.

An exemplary GUI can be provided by an exemplary embodiment of the user interface 150. The GUI can be programmed and/or configured to facilitate formulation of responses to the user-submitted posts.

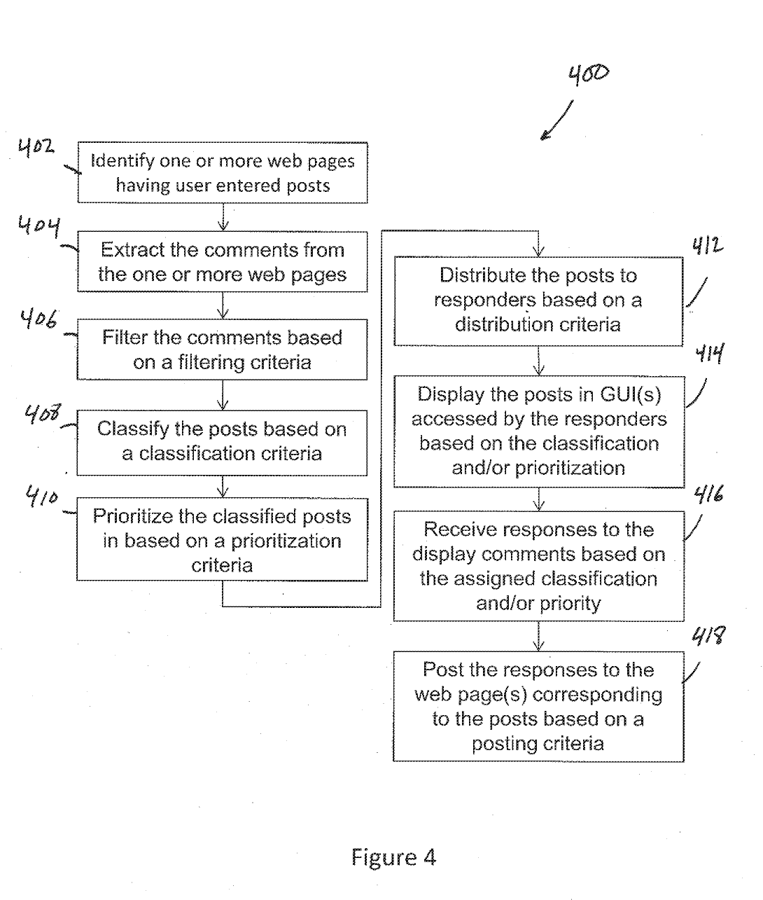

FIG. 4 is a flowchart providing an overview of an exemplary process 400 for processing user-submitted posts. At step 402, one or more sources (e.g., web pages with associated databases and/or servers associated) having user submitted posts can be identified. For example, user-entered posts on websites, such as YouTube, Facebook, Linkedln, Twitter, Pinterest, Tumblr, Instagram, and the like, can be identified. At step 404, the user-submitted posts to the sources, metadata associated with the user-submitted posts (e.g., a user's identity, a time the comment was entered, a geographic location of the user, etc.), and/or metrics data (e.g., number of views, average viewing time of users, etc.) can be extracted for processing by an exemplary embodiment of the environment 100 based on an extraction criteria. Posts to one or more web pages can be stored in one or more databases and/or servers and the extraction engine 110 can be programmed and/or configured to access and download the posts from the databases and/or servers via, e.g., an application program interface (API) or other software interfaces. In exemplary embodiments, user-submitted posts from the data sources can be retrieved periodically and/or when new user-submitted posts are received by the data sources.

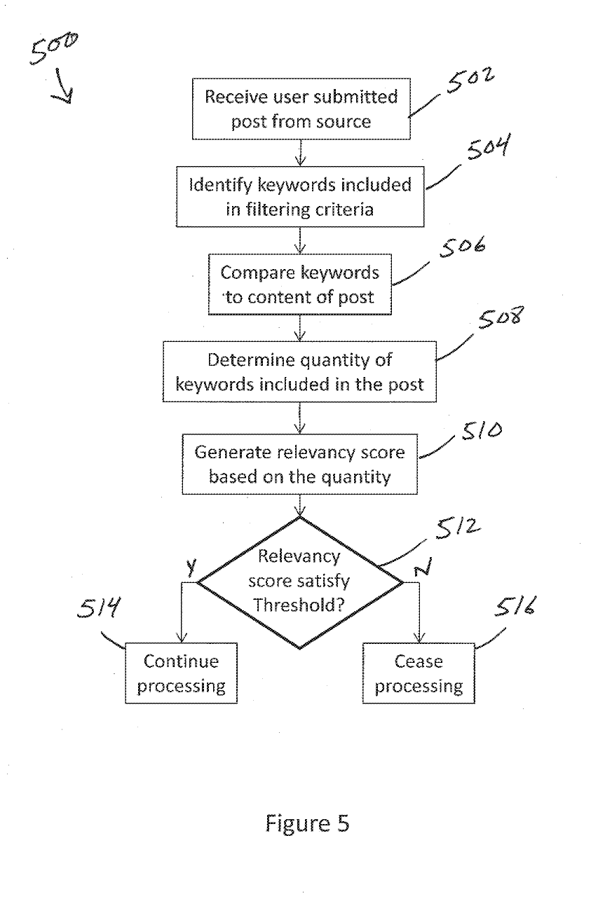

At step 406, the user-submitted posts extracted by the environment can be filtered based on, for example, a filtering criteria. For example, the filter engine 120 can be programmed and/or configured to filter extracted posts based on a relevance, interest, value, and/or any other suitable parameter. One exemplary post filtering process that can be implemented in accordance with exemplary embodiments of the present disclosure is shown in FIG. 5.

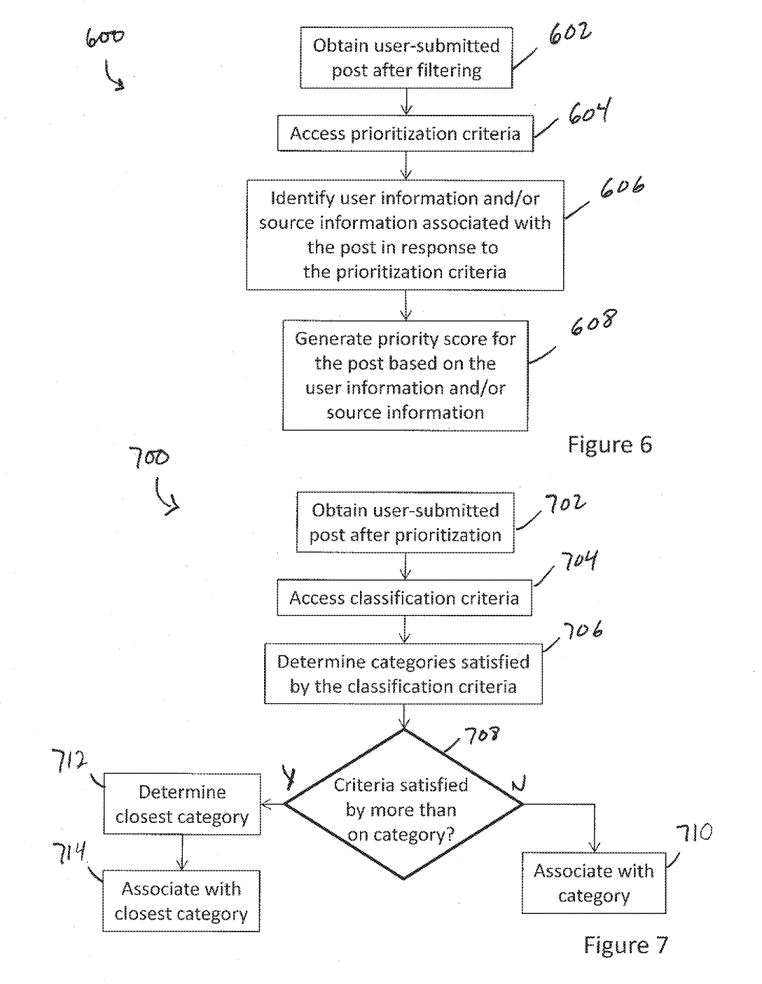

At step 408, the filtered posts can be prioritized based on, for example, a prioritization criteria including, for example, one or more factors to generate a priority score to determine a priority of the user-submitted posts relative to each other. The relative priority of the user-submitted posts can change dynamically with time and/or when new user-submitted posts are received. The prioritization of the user-submitted posts can determine an order in which a response to the user-submitted posts will be formulated (e.g., user-submitted posts receiving a higher priority generally receive a response before lower priority user-submitted posts). One exemplary prioritization process that can be implemented in accordance with exemplary embodiments of the present disclosure is shown in FIG. 6.

At step 410, the filtered and prioritized user-submitted posts can be classified based on, for example, a classification criteria, which can be used by the classification engine to classify the user-submitted posts. In some embodiments, classification criteria to classify the user-submitted posts can be based on the subject matter or nature of the user-submitted posts. Prioritizing the user-submitted posts before classifying the user-submitted posts permits the environment to include a high priority category and/or a low priority category such that user-submitted posts receiving a high priority can be inserted in the high priority category by the classification engine 130. One exemplary classification process that can be implemented in accordance with exemplary embodiments of the present disclosure is shown in FIG. 7.

While the present embodiment provides for prioritizing the user-submitted posts before classifying the user-submitted posts, those skilled in the art will recognize that exemplary embodiments can classify the user-submitted posts and subsequent prioritize the user submitted posts on a category-by-category basis. Furthermore, those skilled in the art will recognize that exemplary embodiments of the process 400 can be performed without actively prioritizing and/or classifying the user-submitted posts.

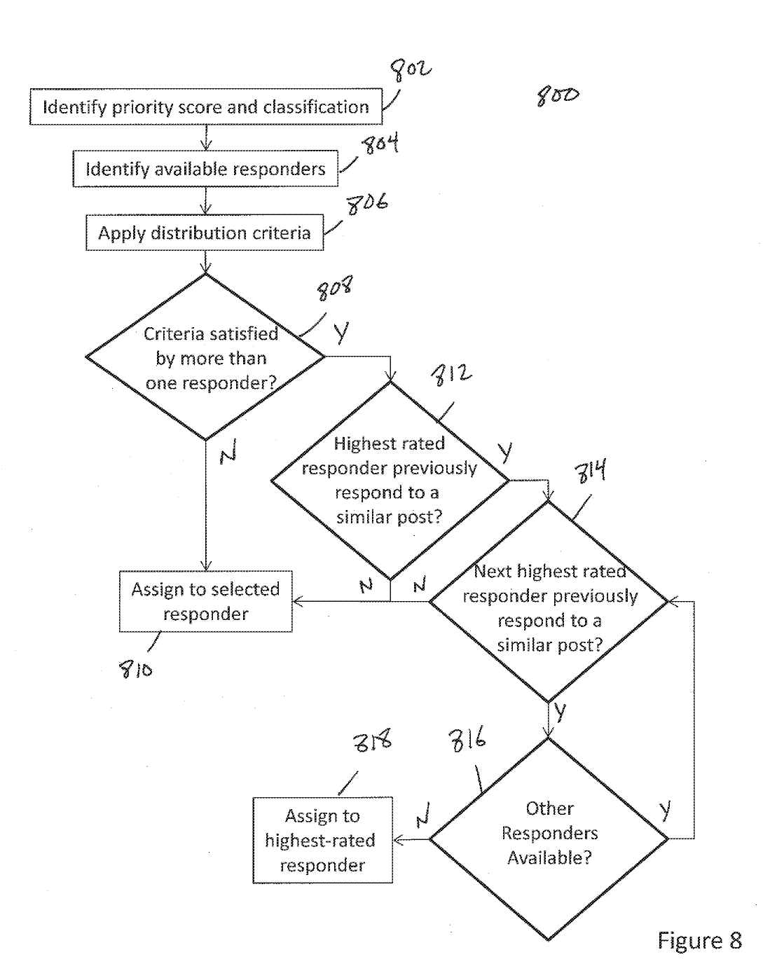

At step 412, the filtered, prioritized, and classified user-submitted posts can be programmatically displayed in one or more GUIs accessible by one or more responders based on, for example, a distribution criteria, which, in some embodiments, can be used to determine which responder(s) receive which user-submitted post(s). One exemplary distribution process that can be implemented in accordance with exemplary embodiments of the present disclosure is shown in FIG. 8.

At step 414, the one or more responders formulate responses to the user-submitted posts. In exemplary embodiments the responders can be one or more persons and/or an automated response engine. At step 416, the response to the user-submitted posts are posted on to data sources (e.g. web pages) corresponding to the user-submitted posts so that the users who posted the user-submitted posts and/or other users of the web pages can view the response upon viewing the web page. In exemplary embodiments, the posting of responses can be managed by the posting engine 170 such that the responses are posted based on satisfaction of posting criteria. One exemplary distribution process that can be implemented in accordance with exemplary embodiments of the present disclosure is shown in FIG. 9.

FIG. 5 is a flowchart showing an exemplary user-submitted post filtering process that can be implemented in accordance with exemplary embodiments of the present disclosure. To begin, at step 502, the filtering engine 110 can receive a user-submitted post from a source via the extraction engine 110 as described herein. The filtering engine 110 retrieves the filtering criteria 112 and identifies keywords included in the filtering criteria 112 at step 504. At step 506, the filtering engine 110 compares the keywords to the content of the user-submitted post, and at step 508 determines a quantity of instances of the keywords in the user-submitted post. Based on this comparison, the filtering engine 110 programmatically generates a relevancy score for the user-submitted post at step 510. At step 512, the relevancy score is compared to a threshold value to determine whether the relevancy score exceeds the threshold value. If so, the environment continues to process the user-submitted post at step 514. Otherwise, the environment ceases processing of the user-submitted post at step 516.

FIG. 6 is a flowchart showing an exemplary post prioritization process that can be implemented in accordance with exemplary embodiments of the present disclosure. To begin, at step 602, the prioritization engine obtains the user-submitted post from the filtering engine. At step 604, the prioritization engine accesses the prioritization criteria, and at step 606, the prioritization engine programmatically identifies user information and/or source information in response to the prioritization criteria. At step 608, the prioritization engine generates a priority score for the user-submitted post based on the user information and/or source information.

FIG. 7 is a flowchart showing an exemplary post classification process that can be implemented in accordance with exemplary embodiments of the present disclosure. At step 702, the classification engine receives the prioritized user-submitted post from the prioritization engine. At step 704, the classification engine accesses the classification criteria, and at step 706, the classification engine determines categories that satisfy the classification criteria. If the user-submitted posts satisfies the classification criteria of a single category (step 708), the classification engine assigns the user-submitted post to the category at step 710. If the user-submitted post satisfies the classification criteria of more than one category (step 708), the classification engine determines the closest category for the user-submitted post at step 712, and associates the user-submitted post with the closest category at step 714.

FIG. 8 is a flowchart showing an exemplary post distribution process that can be implemented in accordance with exemplary embodiments of the present disclosure. The distribution engine can identify the priority score and classification of a user-submitted post at step 802, and can identify available responders at step 804. At step 806, the distribution engine can apply the distribution criteria. If the distribution criteria is satisfied by a single responder (step 808), the distribution engine assigns user-submitted post to the selected responder at step 810. If the distribution criteria is satisfied by more than one responder (step 808), the distribution engine determines if the highest-rated responder has previously responded to a similar user-submitted post at step 812. If not, the distribution engine selects the highest rated responder and assigns the user-submitted post to the responder at step 810. If the highest-rated responder has previously responded to a similar user-submitted post (step 812), the distribution engine determines if the next highest-rated responder has previously responded to a similar user-submitted post at step 814. If not, the distribution engine selects the next highest rated responder and assigns the user-submitted post to the responder at step 810. If the next highest-rated responder has previously responded to a similar user-submitted post (step 814), the distribution engine determines if there are any other responders at step 816. If there are other available responders, the distribution engine determines if next highest-rated responder has previously responded to a similar user-submitted post at step 814. Otherwise, the distribution engine selects the next highest rated responder and assigns the user-submitted post to the highest-rated responder at step 818.

FIG. 9 is a flowchart showing an exemplary response posting process 900 that can be implemented in accordance with exemplary embodiments of the present disclosure. At step 902, the posting engine can receive a response to be posted to a source from which the user-submitted post was extracted. At step 904, the posting engine retrieves the post criteria, which includes a condition to be satisfied before the response can be posted. As one example, the condition can be a quantity of time since the last response was posted to the source. At step 906, the posting engine determines whether the condition has been satisfied. If not, the posting engine repeats step 904. Otherwise, the posting engine posts the response at step 908.

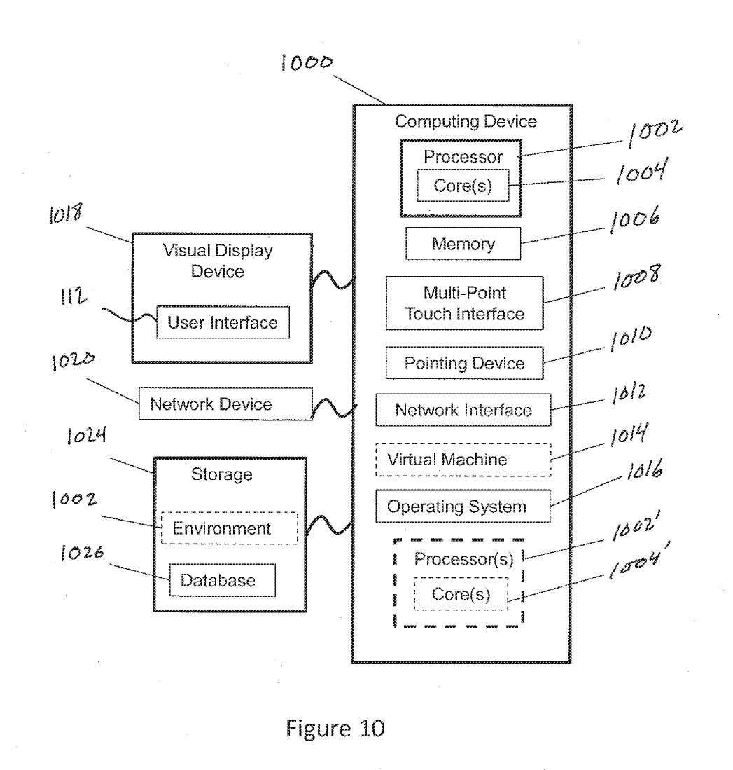

FIG. 10 is a block diagram of an exemplary computing device 1000 that may be used to implement exemplary embodiments of the environments 100, 100′, and/or 100″ described herein. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store computer-readable and computer-executable instructions or software for implementing exemplary embodiments of the environments 100, 100′, and/or 100″. The computing device 1000 also includes configurable and/or programmable processor 1002 and associated core 1004, and optionally, one or more additional configurable and/or programmable processor(s) 1002′ and associated core(s) 1004′ (for example, in the case of computer systems having multiple processors/cores), for executing computer-readable and computer-executable instructions, code, or software stored in the memory 1006 and other programs for controlling system hardware. Processor 1002 and processor(s) 1002′ may each be a single core processor or multiple core (1004 and 1004′) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, MRAM, EDO RAM, and the like. Memory 1006 may include other types of memory as well, or combinations thereof.

A user may interact with the computing device 1000 through a visual display device 1018, such as a computer monitor, which may display one or more graphical user interfaces 112 that may be provided in accordance with exemplary embodiments. The computing device 1000 may include other I/O devices for receiving input from a user, for example, a keyboard or any suitable multi-point touch interface 1008, and a pointing device 1010 (e.g., a mouse). The keyboard 1008 and the pointing device 1010 may be coupled to the visual display device 1018. The computing device 1000 may include other suitable conventional I/O peripherals.

The computing device 1000 may also include one or more storage devices 1024, such as a hard-drive, CD-ROM, or other computer readable media, for storing data and computer-readable instructions, executable code and/or software that implement exemplary embodiments of environments 100, 100′, and/or 100″ and associated processes described herein. For example, the computing device can execute the instructions, code, and/or software to provide the GUIs described herein and/or to perform the steps of the processes described herein. Exemplary storage device 1024 may also store one or more databases for storing any suitable information required to implement exemplary embodiments. For example, exemplary storage device 1024 can store one or more databases 1026 for storing information, such as extracted, filtered, prioritized, and/or classified user-submitted posts, responses to the user-submitted posts, metadata associated with the user-submitted posts, metrics associated with the data sources from which the one or more user-submitted posts are extracted, information associated with responders to the user-submitted posts, information associated with the users submitting the user-submitted posts, metrics associated with responses to the user submitted posts, and/or any other suitable information/data that can be used by embodiments of the environments 100, 100′, and/or 100″ described herein. The databases may be updated manually or automatically at any suitable time to add, delete, and/or update one or more items in the databases.

The computing device 1000 can include a network interface 1012 configured to interface via one or more network devices 1020 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 1000 can include one or more antennas 1030 to facilitate wireless communication (e.g., via the network interface) between the computing device 1000 and a network. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

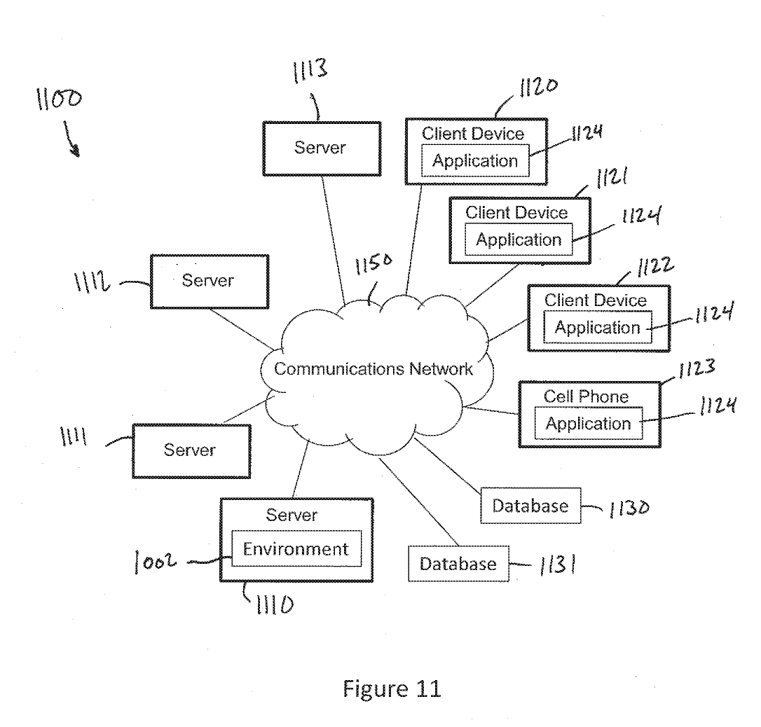

FIG. 11 is a block diagram of an exemplary client-server environment 1100 configured to implement an exemplary environment 1002 for processing user submitted posts, such as embodiments of the environments 100, 100′, and 100″. The environment 1100 includes servers 1110-1113 operatively coupled to clients 1120-1123, via a communication network 1150, which can be any network over which information can be transmitted between devices communicatively coupled to the network. For example, the communication network 1150 can be the Internet, an Intranet, virtual private network (VPN), wide area network (WAN), local area network (LAN), and the like. The environment 1100 can include repositories or databases 1130-1131, which can be operatively coupled to the servers 1110-1113, as well as to clients 1120-1123, via the communications network 1150. The servers 1110-1113, clients 1120-1123, and databases 1130-1131 can be implemented as computing devices. Those skilled in the art will recognize that the database devices 1130-1131 can be incorporated into one or more of the servers 1110-1113 such that one or more of the servers can include databases. In an exemplary embodiment, the environment 1002 can be implemented by the server 1110. The servers 1111-1113 can host sources, such as web pages having user-submitted posts.

In an exemplary operation, the server 1110 executing the engines of the environment 1002 (e.g., extraction engine 110, filter engine 120, classification engine 130, prioritization engine 140, distribution engine 150, user interface 160, posting engine 170) can communicate with one or more of the servers 1111-1113 based on an extraction criteria to extract user-submitted posts from sources (e.g., web pages) hosted by the servers 1112-1113, metadata associated with the user-submitted posts, and/or metrics associated with the source. For example, the engines of the environment 1002 can interact with one or more APIs to interface with applications implemented by the servers 1111-1113 to access one or more databases storing the user-submitted posts, metadata, and/or metrics. Once the environment has retrieved the user-submitted posts, metadata, and/or metrics, the environment 1002 processes the user-submitted posts, metadata, and/or metrics as described herein to filter the user-submitted posts, prioritize the user-submitted, classify the user-submitted posts, select one or more responders to the user-submitted posts, and distribute the user-submitted posts to the one or more selected responders, which may access the user-submitted posts processed by the environment 1002 via the client devices 1120-1123.

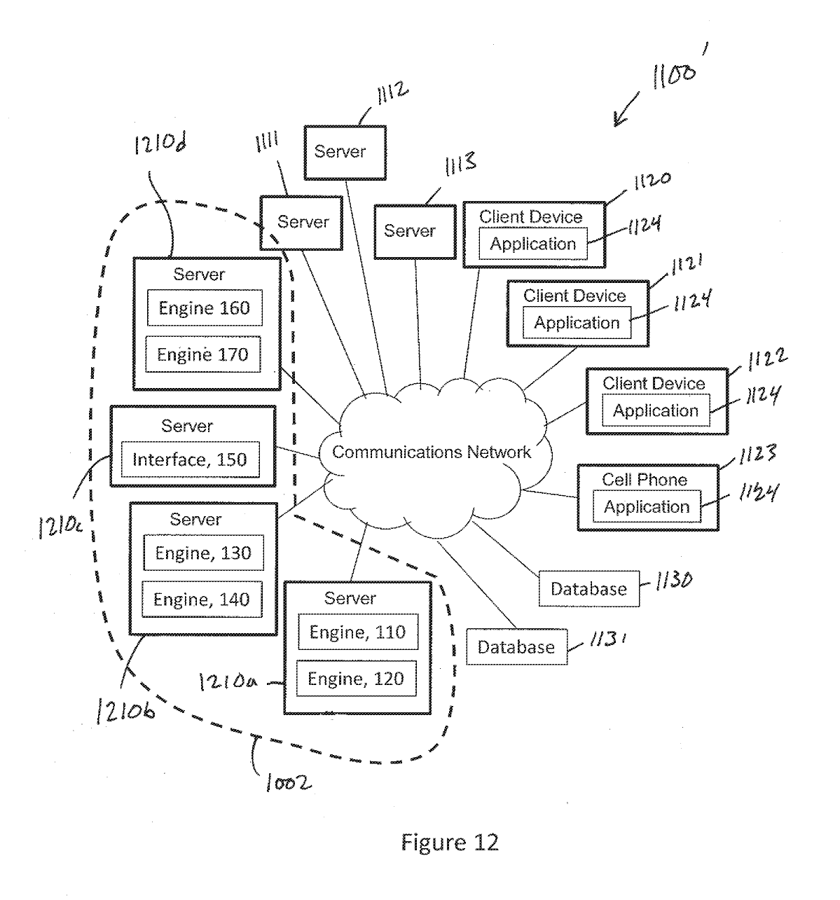

While the environment 1002 is shown as being executed by the server 1002, those skilled in the art will recognize that the environment 1002 can be distributed across multiple servers, where each server implements one or more of the engines of the environment. For example, FIG. 12 shows an exemplary client-server environment 1100′ providing a distributed embodiment of the environment for processing user-submitted posts extracted from one or more sources. An operation of the client-server environment is similar to that of the 1100 except that the engines are distributed across multiple servers. For example, the engine 110 and 120 are resident on server 1210a, the engine 130 and 140 are resident on server 1210b, the user interface 150 is resident on server 1210c, and the distribution engine 160 and posting engine 170 are resident on sever 1210d.

Referring again to FIG. 11, in the present embodiment, the client devices 1120-1123 can be operated by responders to facilitate interaction with the environment 1002. The client devices 1120-1123 can each include a client side application 1124 programmed and/or configured to interact with the server 1110. In the present embodiment, the client devices 1120-1123 can be computing devices including, for example, portable or mobile computing devices. In one embodiment, the client-side application 1124 implemented by the client devices 1120-1123 can be a web-browser capable of navigating to one or more web pages hosting GUIs of the environment 1002. In some embodiments, the client-side application 1124 implemented by one or more of the client devices 1120-1123 can be an application specific to the environment 1002 installed on the client devices 1120-1122 to permit interaction with the environment 1002. As one example, the application specific to the environment 1002 can be a mobile application installed and executed by a portable computing device. In exemplary embodiments, the client devices 1120-1123 can be configured to communicate with the network 1150 via wired and/or wireless communication.

Prior to accessing the environment 1110, the responders may be required to log into the environment by entering a username and password into a prompt displayed by their client devices 1120-1123. Upon logging into the environment 1002, the environment 1002, via the server 1110, can transmit one or more user-submitted posts to the client devices 1120-1123. As an example, in some embodiment, the environment 1002 can provide one or more GUIs populated with user-submitted posts, metadata, and/or metrics to the client devices 1120-1123 to be processed and displayed on the client device via the client-side application 1124. As another example, the client-side application can be programmed to provide the one or more GUIs and the environment 1002, via the server 1110, can transmit data (e.g., user-submitted posts, metadata, and/or metrics to the client devices 1120-1123 to be incorporated into the GUI.

Responders can enter responses in the application-side application 1124, and the client devices 1120-1123 can transmit the responses to the sever 1110 for processing by the environment 1002, which can transmit (e.g., via the posting engine 170) the responses to the server(s) from which user-submitted posts corresponding to the responses originated. As described herein, the environment 1002 can determine whether a posting criteria has been satisfied prior to transmitting a response.

The databases 1130-1131 can store information for use by the environment 1002. For example, the database 1130-1131 can store extracted, filtered, prioritized, and/or classified user-submitted posts, responses to the user-submitted posts, metadata associated with the user-submitted posts, metrics associated with the data sources from which the one or more user-submitted posts are extracted, information associated with responders to the user-submitted posts, information associated with the users submitting the user-submitted posts, metrics associated with responses to the user submitted posts, and/or any other suitable information/data that can be used by embodiments of the environments 1002 as described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A computer-implemented method of processing user-submitted posts from one or more sources, the method comprising:
receiving a user-submitted post from a source;
executing code to programmatically assign a priority to the user-submitted post based on a priority criteria;
displaying the user-submitted post in a graphical user interface (GUI) based on the priority;
receiving a response to the user-submitted post via the graphical user interface; and
transmitting a response to the user-submitted post to the source for display by the source.

2. The method of claim 1, wherein receiving a user submitted post comprises:
executing code to interact with a server associated with the source; and
extracting the user-submitted post from the server according to an extraction criteria.

3. The method of claim 1, further comprising:
applying a filter to the user-submitted post to determine whether to assign a priority to the user-submitted post; and
assigning the priority to the user-submitted post open satisfaction of a filtering criteria.

4. The method of claim 1, further comprising identifying user information for a user who submitted the user-submitted post.

5. The method of claim 4, wherein executing code to programmatically assign a priority to the user-submitted post based on a priority criteria comprises assigning the priority to the user-submitted post based on the user information.

6. The method of claim 1, further comprising identifying metrics for the source of the user-submitted post.

7. The method of claim 6, wherein executing code to programmatically assign a priority to the user-submitted post based on a priority criteria comprises assigning the priority to the user-submitted post based on the metrics.

8. The method of claim 1, further comprising identifying user information for a user who submitted the user-submitted post and metrics for the source of the user-submitted post.

9. The method of claim 8, wherein executing code to programmatically assign a priority to the user-submitted post based on a priority criteria comprises assigning the priority to the user-submitted post based on the user information and the metrics.

10. The method of claim 1, wherein executing code to programmatically assign a priority to the user-submitted post based on a priority criteria comprises assigning the priority to the user-submitted post based on a content of the of the user-submitted post.

11. The method of claim 1, further comprising executing code to assign the user-submitted post to a category based on a classification criteria.

12. The method of claim 11, wherein the priority is assigned to the user-submitted post prior to assigning the user-submitted post to a category.

13. The method of claim 11, wherein the user-submitted post is assigned to a category prior to assigning a priority to the user-submitted post.

14. The method of claim 1, further comprising:
selecting a responder to provide the response to the user-submitted post; and
distributing the user-submitted to the responder in response to the selecting.

15. The method of claim 14, wherein the responder is selected based on a responder rating.

16. The method of claim 14, wherein the responder is selected based on the priority assigned to the user-submitted post.

17. The method of claim 1, wherein transmitting the response comprises:
executing code to determine whether a posting criteria has been satisfied; and
transmitting the response in response to satisfaction of the posting criteria.

18. The method of claim 17, wherein the posting criteria comprises a condition to be satisfied.

19. The method of claim 18, wherein the condition comprises a quantity of time that has elapsed since a previous response was transmitted to the source.

20. A system for processing user-submitted posts from one or more sources, the system comprising:
a non-transitory computer-readable medium storing executable code for processing user-submitted posts from one or more sources; and
a processing device in communication with the non-transitory computer-readable medium and programmed to execute the executable instructions to:
receive a user-submitted post from a source;
assign a priority to the user-submitted post based on a priority criteria;
display the user-submitted post in a graphical user interface (GUI) based on the priority; and
transmit a response to the user-submitted post to the source for display by the source.
